(19) United States
(12) Patent Application Publication
(10) Pub. No.: US 2020/0002497 A1
(43) Pub. Date: Jan. 2, 2020

(54) LOW DIELECTRIC CONSTANT POROUS EPOXY-BASED DIELECTRIC

(71) Applicant: Georgia Tech Research Corporation, Atlanta, GA (US)

(72) Inventors: Paul A. KOHL, Atlanta, GA (US); Oluwadamilola PHILLIPS, Atlanta, GA (US); Jared SCHWARTZ, Atlanta, GA (US); Jisu JIANG, Atlanta, GA (US); Anthony ENGLER, Atlanta, GA (US)

(21) Appl. No.: 16/489,533

(22) PCT Filed: Feb. 28, 2018
(86) PCT No.: PCT/US18/20268

§ 371 Date: Aug. 28, 2019

Related U.S. Application Data
(60) Provisional application No. 62/464,664, filed on Feb. 28, 2017.

(51) Int. Cl. C08J 9/02; C08G 59/24; C08G 59/68; C08G 59/42; C08J 5/18; B29C 67/20

(52) U.S. Cl. CPC C08J 9/02; C08G 59/245; C08G 59/686; C08G 2101/00; C08J 5/18; B29C 67/202; C08G 59/4269

(57) ABSTRACT

Disclosed herein are compositions comprising an epoxy-functionalized sacrificial polymer, wherein the sacrificial polymer decomposes into one or more gaseous decomposition products at a temperature of 180° C. or less for a period of time of 24 hrs or less. Also disclosed are compositions comprising a copolymer derived from an epoxy resin; an epoxy-functionalized sacrificial polymer; and optionally a crosslinker. The epoxy-functionalized sacrificial polymer can be derived from a polycarbonate. Methods of preparing the copolymers described herein are also disclosed. Porous films derived from the copolymers described herein, wherein a majority of the sacrificial polymer in the composition has been degraded to form pores in the porous film are also disclosed.

### CROSS REFERENCE TO RELATED APPLICATIONS

This application claims the benefit of priority to U.S. Provisional Application No. 62/464,664, filed Feb. 28, 2017, which is incorporated by reference herein in its entirety.

### BACKGROUND

Printed wiring boards (PWB) are used in electronic devices to mechanically hold and electrically interconnect integrated circuits. Thus, the mechanical and electrical properties of a PWB are important to the performance of an electrical system, such as a computer or cell phone. PWBs can be made of FR4 epoxy resin and fiberglass. Higher performance PWB's are in great demand because the electrical systems operate at higher frequency and are more compact (that is, seek to place the integrated circuits closer together). The dielectric constant of the FR4 epoxy resin is important because it affects the speed and attenuation of the high frequency electrical signals carried by the metal traces in the PWB. Electrical performance can be improved by decreasing the dielectric constant of the epoxy insulator. The dielectric constant is a complex number composed of the in-phase (or real component) called the permittivity, and the out-of-phase component (or imaginary) part called the loss. The ratio of the loss-to-permittivity is called the loss tangent. Lower permittivity and loss are highly desirable.

Epoxy resins are commercially used in the fabrication of PWBs and integrated circuit package substrates because they have an acceptable dielectric constant, good adhesive strength, high modulus, high thermal stability, and are solvent resistant (Jin, et al., “Journal of Industrial and Engineering Chemistry Synthesis and Application of Epoxy Resins: A Review,” J. Ind. Eng. Chem., 29:1 (2015)). However, advanced polymers are used in applications where lower dielectric constant is needed for higher speed substrates and packages (Chiu, et al., “Analysis of Cu/Low-K Structure under Back End of Line Process,”Microelectron. Eng., 85(10):2150 (2008); Vilmay, et al., “Characterization of Low-K SiOCH Dielectric for 45 Nm Technology and Link between the Dominant Leakage Path and the Breakdown Localization,”Microelectron. Eng., 85(10):2075 (2008); Broussous, et al., “Porosity and Structure Evolution of a SiOCH Low KMaterial during Post-Etch Cleaning Process,”Microelectron. Eng., 84(11):2600 (2007); Volksen, et al., “Low Dielectric Constant Materials,” Chem. Rev., 110:56 (2010)). High parasitic capacitance can cause interconnect delay for electronic devices and increase energy consumption (Maier, “Low Dielectric Constant Polymers for Microelectronics,”Prog. Polym. Sci., 26(1):3 (2001); Kohl, “Low-Dielectric Constant Insulators for Future Integrated Circuits and Packages,”Annu. Rev. Chem. Biomol. Eng., 2:379 (2011)). The tradeoff in improving electrical performance through the use of non-epoxy materials comes with high cost and more difficult process conditions. Thus, improved epoxy formulations are desired because they combine existing market acceptance, low cost and simple processing.

Different methods have been investigated to lower the dielectric constant of epoxy polymer films. A hyperbranched epoxy thermoset has been synthesized and cast into film to reduce the dielectric constant by increasing the free volume in the hyperbranched polymer network (De, et al., RSC Adv., 5:35080 (2015)). Silica/epoxy resin nanocomposites have been formulated to produce organic-inorganic hybrid PWBs with reduced dielectric constant based on mesoporous silica (Jiao, et al., “Improved Dielectric and Mechanical Properties of Silica/Epoxy Resin Nanocomposites Prepared with a Novel Organic-Inorganic Hybrid Mesoporous Silica: POSS-MPS,”Mater. Lett., 129:16 (2014)). Oligomeric silsesquioxane has been used to crosslink with the epoxy resin to reduce the dielectric constant due to the organic functional groups on the cage corners that can reduce the polarization of the molecular structure (Pan, et al., “Dielectric and Thermal Properties of Epoxy Resin Nanocomposites Containing Polyhedral Oligomeric Silsesquioxane,” J. Mater. Sci. Res., 2(1):153 (2013)). The epoxy resin backbone has been perfluorinated to lower the dielectric constant by reducing the dipole of the backbone using fluorine as the electron-withdrawing group; however, perfluorinated compounds are expensive and dangerous to produce (Sasaki, et al., “Dielectric Properties of Cured Epoxy Resins Containing the Perfluorobutenyloxy Group,” J. Polym. Sci. Part C: Polym. Lett., 24:249 (1986)).

The incorporation of air in the epoxy resin through the creation of porous regions is another viable approach to reduce the dielectric constant of polymer films because air has a dielectric constant of about one. There are several reported techniques to form porous films, including gas expansion by using gas-blowing agent such as nitrogen (Miller et al., “Microcellular and Nanocellular Solid-State Polyetherimide (PEI) Foams Using Sub-Critical Carbon Dioxide II. Tensile and Impact Properties,” Polymer., 52(13):2910 (2011)), concentrated emulsion by polymerizing one phase and selectively removing the dispersed liquid phase (Wang, Z et al., “Interconnected Porous Epoxy Monoliths Prepared by Concentrated Emulsion Templating,” J. Colloid Interface Sci., 338(1):145 (2009)), thermally induced phase separation by freeze-drying the solvent below the glass transition temperature (Tg) of the polymer (Matsuyama et al., “D. R. L. Formation of Anisotropic Membranes via Thermally Induced Phase Separation,” Polymer., 40:2289 (1999)), and chemically induced phase separation by crosslinking the polymer to form two phases followed by removal of the solvent to create pores (Kiefer, et al., “Macroporous Thermosets via Chemically Induced Phase Separation,”Microporous Macroporous Mater., 431(95):527 (1996); Li, et al., “Porous Epoxy Monolith Prepared via Chemically Induced Phase Separation,” Polymer., 50(6):1526 (2009)). Despite the large pore volume created using these methods, the pores are either large or open-pores, leading to the formation contiguous pathways through the polymer film. This can significantly deteriorate the mechanical property of the film, making them undesirable in preparation for PWB substrate.

What are thus needed are compounds, compositions, and methods for modifying existing epoxy resin formulations to achieve lower dielectric constant. The compounds, compositions, and methods disclosed herein address these and other needs.

### SUMMARY

Disclosed herein are compounds, compositions, and methods for making and using such compounds and compositions. In further aspects compositions comprising an epoxy-functionalized sacrificial polymer, wherein the sacrificial polymer decomposes into one or more gaseous decomposition products at a temperature of 180° C. or less for a period of time of 24 hrs or less. Also disclosed are compositions comprising a copolymer derived from an epoxy resin; an epoxy-functionalized sacrificial polymer; and optionally a crosslinker for polymer formulations. Further disclosed are compositions comprising a copolymer derived from an epoxy resin; a polycarbonate sacrificial polymer; and optionally a crosslinker. Also disclosed are porous films comprising an epoxy resin having a plurality of closed pores and, optionally, fiberglass. Printed wiring boards comprising such films are also disclosed.

In some embodiments, the epoxy-functionalized sacrificial polymer is derived from a polycarbonate, a polyaldehyde, a polysulfone, a polynobornene, a polycarbamate, or a combination thereof. In specific embodiments, the sacrificial polymer can include a polycarbonate comprising repeating units represented by the general formula of:

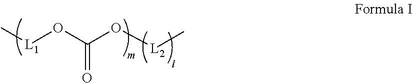

wherein L₁ and L₂ independently represent substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-aryl, substituted or unsubstituted C₆ to C₂₀-heteroaryl; m is an are integer from 1 to 10,000; and 1 is an integer from 0 to 10,000. In some examples of Formula I, m is equal to 2 to 3,000, preferably from 2 to 1,000, more preferably from 2 to 50. In some examples of Formula I, l is equal to 2 to 3,000, preferably from 2 to 1,000, more preferably from 2 to 50. The sacrificial polymer can have a molecular weight of 1,000 Da or higher, preferably from 1,000 Da to 10,000 Da, more preferably from 2,000 Da to 6,000 Da.

In some examples, the sacrificial polymer includes a polycarbonate selected from the group consisting of polypropylene carbonate (PPC), polyethylene carbonate (PEC), poly(propylene carbonate)-co-poly(ethylene carbonate), polybutylene carbonate (PBC), polycyclohexane carbonate (PCC), poly cyclohexane propylene carbonate (pCPC), polynorbornene carbonate (PNC), a blend thereof, and a copolymer thereof.

The sacrificial polymer can be present in a copolymer in an amount of from greater than 0% to 60% by weight, preferably from 5% to 35% by weight, more preferably from 10% to 30% by weight, based on the total weight of the polymers in the composition.

In certain embodiments, the sacrificial polymer can be further derived from a crosslinker. The crosslinker can comprise an amine, mercaptan, or an anhydride functional group. In some examples, the crosslinker is selected from aliphatic amine, alicyclic amine, aliphatic aromatic amine, mercaptan, polymercaptan, anhydride (e.g., styrene maleic anhydride, phthalic anhydride, trimellitic anhydride, pyrometllitic anhydride, benzophenone tricarboxylic anhydride, ethylene glycol bistrimellitate, glycerol tristrimellitate, tetrahydrophthalic anhydride, methyltetrahydrophthalic anhydride, endomethylene tetrahydrophthalic anhydride, methylenedomethylene tetrahydrophthalic anhydride, methylbutenyl tetrahydrophthalic anhydride, dodecenyl succinic anhydride, hexahydrophthalic anhydride, hexahydro-4-methylphthalic anhydride, succinic anhydride, methylcyclohexene dicarboxylic anhydride, alkylstyrene-maleic anhydride copolymer, chloredic anhydride, and polyazelaic polyanhydride), boro trifluoride-amine complex, dicyandiamide, or a combination thereof. In specific examples, the crosslinker comprises a maleated anhydride such as styrene maleic anhydride.

As described herein, the copolymer includes an epoxy resin. In particular, the copolymer can include one or more epoxy resins. The epoxy resin can comprise repeating units represented by the general formula of:

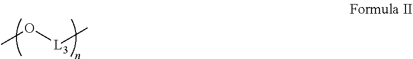

wherein L₃ is selected from substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-aryl, substituted or unsubstituted C₆ to Cm-heteroaryl; and n is an integer from 1 to 10,000. In some examples of Formula II, n is equal to 2 to 10,000, preferably from 2 to 3,000, more preferably from 2 to 1,000, most preferably from 2 to 50. In specific examples, the epoxy resin is derived from one or more of bisphenol diglycidyl ether, diglycidyl phthalate, diglycidyl adipate, diglycidyl isophthalate, di(2,3-epoxybutyl) adipate, di(2,3 epoxybutyl)oxalate, di(2,3 epoxyhexyl) succinate, di(3,4-epoxybutyl)maleate, di(2,3-epoxyoctyl) pimelate, di(2,3-epoxybutyl)phthalate, di(2,3-epoxyoctyl) tetrahydrophthalate, di(4,5-epoxydodecyl)maleate, di(2,3-epoxybutyl)terephthalate, di(2,3 epoxypentyl)thiodipropionate, di(5,6-epoxytetradecyl)diphenyldicarboxylate, di-(3,4-epoxyheptyl) sulfonyldibutyrate, tri(2,3-epoxybutyl) 1,2,4-butanetricarboxylate, di 5,6-epoxypentadecyl tartarate, di(4,5-epoxytetradecyl)maleate, di(2,3 epoxybutyl) azelate, di(3,4-epoxybutyl)citrate, di(5,6 epoxyoctyl)cyclohexanel, 3-dicarboxylate, di 4,5-epoxyoctadecyl malonate.

The copolymer disclosed herein can comprise a repeating unit as shown in Formula III:

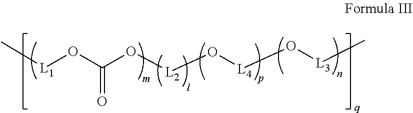

wherein L₁, L₂, and L₃ independently represent substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-aryl, substituted or unsubstituted C₆ to Cm-heteroaryl; L₄ represents a crosslinker; l is an integer from 0 to 100,000; m is an integer from 1 to 100,000; n is an integer from 1 to 100,000; p is an integer from 0 to 100,000; and q is an integer from 1 to 100,000.

Methods of preparing the copolymers described herein are also disclosed. The method can include blending an expoxidized sacrificial polymer with one or more epoxy resins, optionally a crosslinker, and a solvent to form a solution; and curing the solution comprising the expoxidized sacrificial polymer, the epoxy resin, and the optional crosslinker to form the copolymer. In certain embodiments, the solution can be cured to form the copolymer by heating the blend or by using a suitable catalyst for reducing epoxy. In some embodiments, the method of preparing the copolymer can include epoxidizing a sacrificial polymer to form an epoxidized sacrificial polymer; optionally grafting the epoxidized sacrificial polymer onto a crosslinker to form a grafted epoxidized sacrificial polymer; blending the epoxidized sacrificial polymer or grafted epoxidized sacrificial polymer with an epoxy resin and a solvent to form a solution; and curing the solution comprising the epoxidized sacrificial polymer or grafted epoxidized sacrificial polymer and the epoxy resin to form a copolymer. The copolymers formed from the methods described herein can be crosslinked/entangled.

In some embodiments, epoxidizing the sacrificial polymer can include reacting the sacrificial polymer with an epoxide precursor to form a capped sacrificial polymer; and oxidizing the epoxide precursor in the capped sacrificial polymer to form the epoxidized sacrificial polymer. The epoxide precursor and hydroxyl end-groups present in the sacrificial polymer can be present in a molar ratio of from 2:1 to 200:1, preferably from 2:1 to 40:1, more preferably from 2:1 to 20:1. The epoxide precursor can include an alkene-containing functional group, such as an allyl-functional group. The allyl-functional group can be oxidized with an organic peroxide, a dioxirane, a metal complex catalyst, ozonolysis, or a photocatalysis oxidizing agent such as Mn-salen catalyst, titanium tetraisopropoxide, tertbutyl hydroperoxide, yttirium-chiral biphenyldiol, m-chloroperoxybenzoic acid, sodium periodate, or hydrogen peroxide.

In other embodiments, epoxidizing the sacrificial polymer can include reacting the sacrificial polymer with an epihalohydrin such as epichlorohydrin, epifluorohydrin, or epibromohydrin in the presence of a base. The epihalohydrin and hydroxyl end-groups present in the polycarbonate can be present in a molar ratio of from 2:1 to 200:1, preferably from 2:1 to 40:1, more preferably from 2:1 to 20:1.

Porous film derived from the copolymers described herein are also disclosed, wherein a majority of the sacrificial polymer in the composition has been degraded to form pores in the porous film. In some embodiments, at least 60%, at least 75%, at least 80%, at least 90%, or at least 95% by weight of the sacrificial polymer in the composition has been degraded. Degradation of the sacrificial polymer can be by thermal decomposition. In some embodiments, the degradation temperature is at least 90° C. such as at least 150° C. or at least 180° C. At least 5%, such as greater than 10%, or from 5% to 40% of the pores in the porous films have a closed cell structure. The pores can have an average pore size of less than 1 micron, preferably less than 500 nm, more preferably 100 nm or less. The film can have a pore volume of from greater than 0% to 50%, such as from 1% to 50% or from 5% to 40%, based on the volume of the film.

Methods of forming the porous film comprising depositing a layer comprising an epoxy resin, an epoxy-functionalized sacrificial polymer, and optionally a crosslinker on a substrate; curing the epoxy resin, the epoxidized sacrificial polymer, and the optional crosslinker to form a copolymer; causing a majority of the sacrificial polymer present in the copolymer to decompose into one or more gaseous decomposition products; and removing the one or more gaseous decomposition products by passage through a solid portion of the film are disclosed. In some examples, the method can include reacting the porous film with a hydrophobic compound after step (iii). The hydrophobic compound can comprise a silane functional group such as hexamethyldisilazane. The porous films can exhibit a dielectric constant of less than 3.5, preferably less than 3. The dielectric loss of the porous film can be less than 0.01, preferably less than 0.007.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1A is a ¹H NMR spectrum showing quantitative characterization of the molar ratio of the epoxy end-groups to polypropylene carbonate chain ends determined from integration of ¹H NMR peaks.

FIG. 1B is a group of aligned ¹H NMR spectra for PPC polyol (spectrum a), allyl chloroformate (spectrum b), allyl-PPC (spectrum c), and epoxidized-PPC (spectrum d).

FIG. 2 is a graph showing the thermal decomposition profile for PPC polyol, allyl-PPC, and epoxidized-PPC.

FIG. 3 is a group of aligned ¹H NMR spectrum for SMA (spectrum a), SMA-g-PPG_{0.1} (spectrum b), SMA-g-PPC_{0.2} (spectrum c), and SMA-g-PPC_{0.3} (spectrum d).

FIG. 4 is a graph showing the thermal decomposition profile for SMA-g-PPCₓ.

FIGS. 5A and 5B are graphs showing the thermal decomposition profile for SMA-g-PPCₓ crosslinked films before removal of porogen (FIG. 5A) and after removal of porogen (FIG. 5B).

FIGS. 6A-6D are SEM images of cross-section thickness for nonporous film: 5% porous film (FIG. 6A), 13% porous film (FIG. 6B), 20% porous film (FIG. 6C), and 10% porous film without grafting ePPC (FIG. 6D).

FIGS. 7A-7E are SEM images of pore size for nonporous film (FIG. 7A), 5% porous film (FIG. 7B), 13% porous film (FIG. 7C), 20% porous film (FIG. 7D), and 10% porogen mixed into epoxy without chemical grafting (FIG. 7E).

FIG. 8 is a graph showing nitrogen absorption for films with different pore density.

FIG. 9 is a graph showing the dielectric constant and tangent loss of the films.

FIG. 10 is a graph showing the glass transition temperature for films with different porosity.

FIG. 11 is a graph showing the reduced modulus and hardness for films with different porosity.

FIG. 12 is a graph showing the thermal decomposition profile for polypropylene carbonate and epoxide polypropylene carbonate.

FIG. 13 is a graph showing the refractive index for various films with different porosity.

FIG. 14 contains images showing an average pore size of 30 nm obtained for 20% porous film (top) and an average pore size of over 100 nm obtained for 30% porous film (bottom).

FIG. 15 is a graph showing the reduced modulus and hardness of a film made using 2 kDa epoxidized polypropylene carbonate (ePPC) with styrene maleic anhydride (SMA 4000).

FIG. 16 is a graph showing the dielectric constant of a film at porosity of 0%, 11.3%, and 22.3%.

FIG. 17 is a graph showing the reduced modulus and hardness of a film made using 2 kDa epoxidized polypropylene carbonate (ePPC) with 2 kDa and 4 kDa styrene maleic anhydride (SMA 4000).

FIG. 18 is a graph showing the thermal decomposition profile for 1 kDa epoxide polypropylene carbonate and 1 kDa epoxide polypropylene carbonate in combination with a photoacid generator (PAG).

FIG. 19 is a graph showing the thermal decomposition profile for 2 kDa epoxide polypropylene carbonate and 2 kDa epoxide polypropylene carbonate in combination with a photoacid generator (PAG).

FIG. 20 is a graph showing the thermal decomposition profile for 1 kDa epoxide polypropylene carbonate and 1 kDa epoxide polypropylene carbonate in combination with a photobase generator (PBG).

FIG. 21 is a graph showing the thermal decomposition profile for 2 kDa epoxide polypropylene carbonate and 2 kDa epoxide polypropylene carbonate in combination with a photobase generator (PBG).

FIG. 22 is a schematic drawing showing formation of a porous film.

### DETAILED DESCRIPTION

The present invention can be understood more readily by reference to the following detailed description of the invention and the Examples and Figures included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, exemplary methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### General Definitions

In this specification and in the claims that follow, reference will be made to a number of terms, which shall be defined to have the following meanings:

Throughout the specification and claims the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the polymer” includes mixtures of two or more such polymers, and the like.

“Optional” or “optionally” means that the subsequently described event or circumstance can or cannot occur, and that the description includes instances where the event or circumstance occurs and instances where it does not.

Notwithstanding that the numerical ranges and parameters setting forth the broad scope of the disclosure are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Unless stated otherwise, the term “about” means within 5% (e.g., within 2% or 1%) of the particular value modified by the term “about.”

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

### Chemical Definitions

As used herein, the term “composition” is intended to encompass a product comprising the specified ingredients in the specified amounts, as well as any product which results, directly or indirectly, from combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight component Y, X and Y are present at a weight ratio of 2:5, and are present in such ratio regardless of whether additional components are contained in the mixture.

A weight percent (wt. %) of a component, unless specifically stated to the contrary, is based on the total weight of the formulation or composition in which the component is included. In instances where components (such as solids) are added to a solvent, the weight percent is with respect to the solids content only and does not include the solvent weight.

A mole percent (mol %) of a component, unless specifically stated to the contrary, is based on the total number of moles of each unit of the formulation or composition in which the component is included.

As used herein, “molecular weight” refers to number-average molecular weight as measured by ¹H NMR spectroscopy, unless clearly indicated otherwise.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valencies of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

The term “aliphatic” as used herein refers to a non-aromatic hydrocarbon group and includes branched and unbranched, alkyl, alkenyl, or alkynyl groups.

The term “alkyl” as used herein is a branched or unbranched saturated hydrocarbon group of 1 to 20 carbon atoms, such as methyl, ethyl, n-propyl, isopropyl, n-butyl, isobutyl, t-butyl, pentyl, hexyl, heptyl, octyl, nonyl, decyl, dodecyl, tetradecyl, hexadecyl, eicosyl, tetracosyl, and the like. The alkyl group can also be substituted or unsubstituted. The alkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, cyano, azido, silyl, sulfonyl, sulfinyl, or thiol, as described below.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “alkenyl” as used herein is a branched or unbranched hydrocarbon group of from 2 to 20 carbon atoms with a structural formula containing at least one carbon-carbon double bond. Asymmetric structures such as (A¹A²)C═C(A³A⁴) are intended to include both the E and Z isomers. This may be presumed in structural formulae herein wherein an asymmetric alkene is present, or it may be explicitly indicated by the bond symbol C═C. Non-limiting examples of alkenyl include ethenyl (vinyl), 1-propenyl, 2-propenyl (allyl), iso-propenyl, 2-methyl-1-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, 1-heptenyl, 2-heptenyl, 3-heptenyl, 4-heptenyl, 5-heptenyl, 6-heptenyl, 1-octenyl, 2-octenyl, 3-octenyl, 4-octenyl, 5-octenyl, 6-octenyl, 7-octenyl, 1-nonenyl, 2-nonenyl, 3-nonenyl, 4-nonenyl, 5-nonenyl, 6-nonenyl, 7-nonenyl, 8-nonenyl, 1-decenyl, 2-decenyl, 3-decenyl, 4-decenyl, 5-decenyl, 6-decenyl, 7-decenyl, 8-decenyl, 9-decenyl, 1-undecenyl, 2-undecenyl, 3-undecenyl, 4-undecenyl, 5-undecenyl, 6-undecenyl, 7-undecenyl, 8-undecenyl, 9-undecenyl, 10-undecenyl, 1-dodecenyl, 2-dodecenyl, 3-dodecenyl, 4-dodecenyl, 5-dodecenyl, 6-dodecenyl, 7-dodecenyl, 8-dodecenyl, 9-dodecenyl, 10-dodecenyl, and 11-dodecenyl. The alkenyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, cyano, azido, silyl, sulfonyl, sulfinyl, or thiol, as described below.

The term “alkynyl” as used herein is a branched or unbranched hydrocarbon group of 2 to 20 carbon atoms with a structural formula containing at least one carbon-carbon triple bond. Non-limiting examples of C₂-C₁₂ alkenyl include ethynyl, propynyl, butynyl, pentynyl and the like. The alkynyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, cyano, azido, silyl, sulfonyl, sulfinyl, or thiol, as described below.

The term “aryl” as used herein is a group that contains any carbon-based aromatic group including, but not limited to, benzene, naphthalene, phenyl, biphenyl, phenoxybenzene, aceanthrylene, acenaphthylene, acephenanthrylene, anthracene, azulene, chrysene, fluoranthene, fluorene, as-indacene, s-indacene, indane, indene, phenalene, phenanthrene, pleiadene, pyrene, and triphenylene, and the like. The term “heteroaryl” is defined as a group that contains an aromatic group that has at least one heteroatom incorporated within the ring of the aromatic group. Examples of heteroatoms include, but are not limited to, nitrogen, oxygen, sulfur, and phosphorus. Examples of heteroaryls include, but are not limited to, azepinyl, acridinyl, benzimidazolyl, benzothiazolyl, benzindolyl, benzodioxolyl, benzofuranyl, benzooxazolyl, benzothiazolyl, benzothiadiazolyl, benzo[b][1,4]dioxepinyl, 1,4-benzodioxanyl, benzonaphthofuranyl, benzoxazolyl, benzodioxolyl, benzodioxinyl, benzopyranyl, benzopyranonyl, benzofuranyl, benzofuranonyl, benzothienyl (benzothiophenyl), benzotriazolyl, benzo[4,6]imidazo[1,2-a]pyridinyl, carbazolyl, cinnolinyl, dibenzofuranyl, dibenzothiophenyl, furanyl, furanonyl, isothiazolyl, imidazolyl, indazolyl, indolyl, indazolyl, isoindolyl, indolinyl, isoindolinyl, isoquinolyl, indolizinyl, isoxazolyl, naphthyridinyl, oxadiazolyl, 2-oxoazepinyl, oxazolyl, oxiranyl, 1-oxidopyridinyl, 1-oxidopyrimidinyl, 1-oxidopyrazinyl, 1-oxidopyridazinyl, 1-phenyl-1H-pyrrolyl, phenazinyl, phenothiazinyl, phenoxazinyl, phthalazinyl, pteridinyl, purinyl, pyrrolyl, pyrazolyl, pyridinyl, pyrazinyl, pyrimidinyl, pyridazinyl, quinazolinyl, quinoxalinyl, quinolinyl, quinuclidinyl, isoquinolinyl, tetrahydroquinolinyl, thiazolyl, thiadiazolyl, triazolyl, tetrazolyl, triazinyl, and thiophenyl (i.e. thienyl). The term “non-heteroaryl,” which is included in the term “aryl,” defines a group that contains an aromatic group that does not contain a heteroatom. The aryl and heteroaryl group can be substituted or unsubstituted. The aryl and heteroaryl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, cyano, azido, silyl, sulfonyl, sulfinyl, or thiol, as described herein. The term “biaryl” is a specific type of aryl group and is included in the definition of aryl. Biaryl refers to two aryl groups that are bound together via a fused ring structure, as in naphthalene, or are attached via one or more carbon-carbon bonds, as in biphenyl.

The term “cycloalkyl” as used herein is a non-aromatic carbon-based ring composed of at least three carbon atoms. Examples of cycloalky 20=1 groups include, but are not limited to, cyclopropyl, cyclobutyl, cyclopentyl, cyclohexyl, etc. The term “heterocycloalkyl” is a cycloalkyl group as defined above where at least one of the carbon atoms of the ring is substituted with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, cyano, azido, silyl, sulfonyl, sulfinyl, or thiol, as described herein.

The term “heterocycloalkyl” is a type of cycloalkyl group as defined above where at least one of the carbon atoms and its attached hydrogen atoms, if any, are replaced by O, S, N, or NH. The heterocycloalkyl group and heterocycloalkenyl group can be substituted or unsubstituted. The cycloalkenyl group and heterocycloalkenyl group can be substituted with one or more groups including, but not limited to, alkyl, alkoxy, alkenyl, alkynyl, aryl, heteroaryl, aldehyde, amino, carboxylic acid, ester, ether, halide, hydroxy, ketone, nitro, cyano, azido, silyl, sulfonyl, sulfinyl, or thiol, as described herein.

The term “cycloalkenyl” as used herein is a non-aromatic carbon-based ring composed of at least three carbon atoms and containing at least one double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, and the like.

The term “cyclic group” is used herein to refer to either aryl groups, non-aryl groups (i.e., cycloalkyl, heterocycloalkyl, cycloalkenyl, and heterocycloalkenyl groups), or both. Cyclic groups have one or more ring systems that can be substituted or unsubstituted. A cyclic group can contain one or more aryl groups, one or more non-aryl groups, or one or more aryl groups and one or more non-aryl groups.

The term “aldehyde” as used herein is represented by the formula —C(O)H. Throughout this specification “C(O)” is a short hand notation for C═O, which is also referred to as a carbonyl.

The terms “amine” or “amino” as used herein are represented by the formula NA¹A²A³, where A¹, A², and A³ can be, independently, hydrogen, an alkyl, alkenyl, alkynyl, aryl, heteroaryl, cycloalkyl, cycloalkenyl, heterocycloalkyl, or heterocycloalkenyl group described above.

The term “halide” or “halo” as used herein refers to the halogens fluorine, chlorine, bromine, and iodine.

The term “hydroxyl” as used herein is represented by the formula —OH.

The term “nitro” as used herein is represented by the formula —NO₂.

The term “cyano” as used herein is represented by the formula —CN

The term “azido” as used herein is represented by the formula —N₃.

The term “sulfonyl” is used herein to refer to the sulfo-oxo group represented by the formula —S(O)₂A¹, where A¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above. The term “sulfinyl” is used herein to refer to the sulfo-oxo group represented by the formula —S(O)A¹, where A¹ can be hydrogen, an alkyl, halogenated alkyl, alkenyl, alkynyl, aryl, heteroaryl, cycloalkyl, cycloalkenyl, heterocycloalkyl, or heterocycloalkenyl group described above.

The term sulfuric acid” as used herein is represented by the formula —S(O)OH.

The term “sulfonic acid” as used herein is represented by the formula —S(O)₂OH.

The term “phosphonic acid” as used herein is represented by the formula —P(O)(OH)₂.

The term “thiol” as used herein is represented by the formula —SH.

The term “copolymer” is used herein to refer to a macromolecule prepared by polymerizing two or more different compounds. The compounds used to form the copolymer can include small molecules (also referred to herein as monomers) and/or macromolecules (such as oligomers or polymers). The copolymer can be a random, block, or graph copolymer.

It is to be understood that the compounds provided herein may contain chiral centers. Such chiral centers may be of either the (R-) or (S-) configuration. The compounds provided herein may either be enantiomerically pure, or be diastereomeric or enantiomeric mixtures. It is to be understood that the chiral centers of the compounds provided herein may undergo epimerization in vivo. As such, one of skill in the art will recognize that administration of a compound in its (R-) form is equivalent, for compounds that undergo epimerization in vivo, to administration of the compound in its (S-) form.

As used herein, substantially pure means sufficiently homogeneous to appear free of readily detectable impurities as determined by standard methods of analysis, such as thin layer chromatography (TLC), nuclear magnetic resonance (NMR), gel electrophoresis, high performance liquid chromatography (HPLC) and mass spectrometry (MS), gas-chromatography mass spectrometry (GC-MS), and similar, used by those of skill in the art to assess such purity, or sufficiently pure such that further purification would not detectably alter the physical and chemical properties, such as enzymatic and biological activities, of the substance. Both traditional and modern methods for purification of the compounds to produce substantially chemically pure compounds are known to those of skill in the art. A substantially chemically pure compound may, however, be a mixture of stereoisomers.

Unless stated to the contrary, a formula with chemical bonds shown only as solid lines and not as wedges or dashed lines contemplates each possible isomer, e.g., each enantiomer, diastereomer, and meso compound, and a mixture of isomers, such as a racemic or scalemic mixture.

As used herein, the symbol

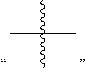

(hereinafter can be referred to as “a point of attachment bond”) denotes a bond that is a point of attachment between two chemical entities, one of which is depicted as being attached to the point of attachment bond and the other of which is not depicted as being attached to the point of attachment bond. For example,

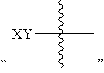

indicates that the chemical entity “XY” is bonded to another chemical entity via the point of attachment bond. Furthermore, the specific point of attachment to the non-depicted chemical entity can be specified by inference. For example, the compound CH₃-A¹, wherein A¹ is H or

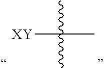

infers that when A¹ is “XY”, the point of attachment bond is the same bond as the bond by which A¹ is depicted as being bonded to CH₃.

Reference will now be made in detail to specific aspects of the disclosed materials, compounds, compositions, articles, and methods, examples of which are illustrated in the accompanying Examples and Figures.

### Sacrificial Polymer

Provided herein are sacrificial polymers (also referred to herein as porogen materials) and methods of making sacrificial polymers, copolymers comprising the sacrificial polymers, and methods of forming compositions comprising the sacrificial polymers. The term “sacrificial polymer” is used herein to describe a portion or all of a polymeric compound that can be converted to a gaseous or liquid species, which can be removed such as by evaporation. The term “sacrificial polymer” also includes a polymer that is employed as a mechanical place holder in a sequence of fabrication steps in which materials such as monomers, oligomers, and/or polymers are processed for producing a copolymer structure; once the copolymer is formed, the sacrificial polymer is removed from the structure while the other materials are maintained in place, thereby producing a porous structure. The disclosed sacrificial polymers include polymer segments or domains that at least partially decompose when a copolymer containing the sacrificial polymer is heated, and preferably substantially decompose if the copolymer is heated to a sufficiently high temperature. The copolymer remaining after the decomposition of the sacrificial can then have pores, e.g., closed pores, where the sacrificial polymer once existed. As used herein the term “substantially decompose” means containing only trivial or inconsequential amounts. For example, after decomposition of the sacrificial polymer, the remaining portions of the copolymer can include less than about 0.5 wt % sacrificial polymer, based on the total weight of the original copolymer (e.g., less than about 0.1 wt % sacrificial polymer, or less than about 0.05 wt % sacrificial polymer. The decomposed sacrificial polymer is removed through the copolymer to form air gaps. Preferably, the decomposition products of the sacrificial polymer are diffusable through the remaining copolymer used for forming the compositions described herein, including epoxides. Preferably, essentially no residue is left in the air gaps of the resultant film after decomposition.

The removal of the sacrificial polymer can, in one embodiment, be accomplished by thermal decomposition and passage of one or more of the decomposition products through the copolymer by diffusion. As herein indicated, the sacrificial materials can undergo thermal decomposition at temperatures of about 450° C. and lower (e.g., about 400° C. and lower, about 350° C. and lower, about 300° C. and lower, about 250° C. and lower, about 220° C. and lower, about 200° C. and lower, about 180° C. and lower, about 170° C. and lower, about 160° C. and lower, or about 150° C. and lower). Thermal decomposition temperatures can be measured by thermal gravimetric analyses. As further described herein, it has been found that by incorporating a photoacid generator (PAG) or a thermal acid generator (TAG), the decomposition temperatures of the sacrificial polymers can be significantly lowered. Without wishing to be bound by theory, a neat sacrificial polymer as disclosed herein, such as propylene carbonate, has the tendency to aggregate with itself while mixing with epoxy resin. Pore size up to 10 microns has been observed previously by mixing 100 kDa polypropylene carbonate with epoxy resin followed by degradation of the polypropylene carbonate to form the pores. Large pore size can affect the mechanical strength of epoxy resins. To reduce or avoid aggregation of pores, two approaches are disclosed herein. First, lower molecular weight sacrificial polymers have been used as the sacrificial materials. Second, end groups of sacrificial polymers have been functionalized to epoxide group to allow better miscibility with epoxy resin.

The average molecular weight of the disclosed sacrificial polymer can be 500 g/mol or more (e.g., 1,000 g/mol or more; 1,500 g/mol or more; 2,000 g/mol or more; 2,500 g/mol or more; 3,000 g/mol or more; 3,500 g/mol or more; 4,000 g/mol or more; 5,000 g/mol or more, 6,000 g/mol or more; 7,000 g/mol or more, 10,000 g/mol or more, 15,000 g/mol or more, 20,000 g/mol or more, 25,000 g/mol or more, 30,000 g/mol or more, 35,000 g/mol or more, or 50,000 g/mol or more). In some examples, the disclosed sacrificial polymer can have an average molecular weight of 50,000 g/mol or less (e.g., 45,000 g/mol or less; 40,000 g/mol or less; 35,000 g/mol or less; 30,000 g/mol or less; 25,000 g/mol or less; 20,000 g/mol or less; 15,000 g/mol or less; 10,000 g/mol or less; 8,000 g/mol or less; 7,000 g/mol or less; 6,000 g/mol or less; 5,000 g/mol or less; 4,000 g/mol or less; 3,500 g/mol or less; 3,000 g/mol or less; 2,500 g/mol or less; 2,000 g/mol or less; 1,500 g/mol or less; or 1,000 g/mol or less). The average molecular weight of the disclosed sacrificial polymer can range from any of the minimum values described above to any of the maximum values described above. For example, the average molecular weight of the sacrificial polymer can be from 500 g/mol to 50,000 g/mol (e.g., from 500 g/mol to 30,000 g/mol, from 500 g/mol to 20,000 g/mol, from 1,000 g/mol to 15,000 g/mol; from 1,000 g/mol to 10,000 g/mol; from 2,000 g/mol to 10,000 g/mol; from 2,000 g/mol to 8,000 g/mol; or from 2,000 g/mol to 6,000 g/mol).

As described herein, the sacrificial polymer can comprise an epoxy-functional group. In some examples, the sacrificial polymer comprises a mono-epoxide. In other embodiments, the sacrificial polymer can comprise a polyepoxide. While terminal epoxy groups in the sacrificial polymer are preferred, such epoxy groups can be in or tethered to the backbone of the sacrificial polymer. Accordingly, the epoxy group in the sacrificial polymer can be an epoxy monomer, oligomer, or polymer. Suitable epoxy compounds include the internal epoxide compounds such as epoxidized fatty compounds, various alicyclic epoxides, and terminal epoxides such as glycidyl-containing compounds.

In general, it is believed that the sacrificial polymers described herein are suited as sacrificial materials in epoxy resins because the sacrificial polymers thermally decompose close to its T_{g}. In other words, the sacrificial polymers remain mechanically stable until the decomposition temperature is reached allowing the polymer to endure the processing steps during manufacture of the copolymer. Suitable sacrificial polymers for use herein include polycarbonates, polyaldehydes, polysulfones, polycarbamates, polynorbornene, polyesters, and polyethers.

Polycarbonate

In some embodiments, the sacrificial polymer can include a polycarbonate polymer. Polycarbonate polymers are suitable sacrificial materials for epoxy resins because of their relatively low decomposition temperature and generation of small volatile molecules upon decomposition that can diffuse through the epoxy polymer matrix. Polycarbonate polymers such as polypropylene carbonate are generally both biodegradable and biocompatible. The polycarbonate polymers have a low glass transition temperature, varying from 10° C. to 45° C. depending on the molecular weight. In addition to their relatively low decomposition temperatures, polycarbonate polymers also exhibit low residual leftover after decomposition. For example, the residue leftover can be less than 10% by weight, less than 5% by weight, or less than 1% by weight of the copolymer. In specific embodiments, only trace amounts of polycarbonate residue is leftover after decomposition.

In specific embodiments, the polycarbonate sacrificial polymer (or polymer domain) can contain repeating units according to the following general formula:

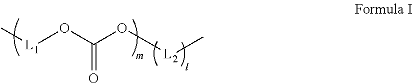

wherein L₁ and L₂ independently represent substituted or unsubstituted linear and branched C₁ to C₄₀-alkyl, substituted or unsubstituted linear and branched C₂ to C₄₀-alkenyl, substituted or unsubstituted linear and branched C₂ to C₄₀-alkynyl, substituted or unsubstituted C₆ to C₄₀-cycloalkyl, substituted or unsubstituted C₆ to C₄₀-heterocycloalkyl, substituted or unsubstituted C₆ to C₄₀-cycloalkenyl, substituted or unsubstituted C₆ to C₄₀-aryl, or substituted or unsubstituted C₆ to C₄₀-heteroaryl;

m is an integer from 1 to 10,000; and

l is an integer from 0 to 10,000.

In some embodiments of Formula I, L₁ and L₂ independently represent substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-heterocycloalkyl, substituted or unsubstituted C₆ to C₂₀-cycloalkenyl, substituted or unsubstituted C₆ to C₂₀-aryl, substituted or unsubstituted C₆ to C₂₀-heteroaryl; and l and m independently are integers from 0 to 10,000, wherein the sum of l and m is at least 1.

In specific examples of Formula I, L₁ and L₂ independently can be chosen from C₁-C₁₀ alkyl, C₂-C₁₀ alkenyl, or C₂-C₁₀ alkynyl, or cycloalkenyl, or heterocycloalkenyl. In more specific examples, L₁ and L₂ independently can be C₁-C₆ alkyl or C₁-C₆ alkenyl. In other examples, the disclosed polycarbonate can include polypropylene carbonate (PPC), polyethylene carbonate (PEC), poly(propylene carbonate)-co-poly(ethylene carbonate), polybutylene carbonate (PBC), polycyclohexane carbonate (PCC), poly cyclohexane propylene carbonate (pCPC), polynorbornene carbonate (PNC), a blend thereof, or a copolymer thereof.

In certain embodiments of Formula I, m is an integer that is equal to 2 or greater, 5 or greater, 10 or greater, 15 or greater, 20 or greater, 25 or greater, 30 or greater, 40 or greater, 50 or greater, from 2 to 3,000, from 2 to 1,000, from 2 to 500, from 2 to 100, or from 2 to 50. In certain embodiments of Formula I, l is an integer that is equal to 2 or greater, 5 or greater, 10 or greater, 15 or greater, 20 or greater, 25 or greater, 30 or greater, 40 or greater, 50 or greater, from 2 to 3,000, from 2 to 1,000, from 2 to 500, from 2 to 100, or from 2 to 50.

The molecular weight of the disclosed polycarbonate polymer can be 500 g/mol or more (e.g., 1,000 g/mol or more; 1,500 g/mol or more; 2,000 g/mol or more; 2,500 g/mol or more; 3,000 g/mol or more; 3,500 g/mol or more; 4,000 g/mol or more; 5,000 g/mol or more, 6,000 g/mol or more; 7,000 g/mol or more, or 10,000 g/mol or more). In some examples, the polycarbonate can have a molecular weight of 20,000 g/mol or less (e.g., 15,000 g/mol or less; 10,000 g/mol or less; 8,000 g/mol or less; 7,000 g/mol or less; 6,000 g/mol or less; 5,000 g/mol or less; 4,000 g/mol or less; 3,500 g/mol or less; 3,000 g/mol or less; 2,500 g/mol or less; 2,000 g/mol or less; 1,500 g/mol or less; or 1,000 g/mol or less).

The molecular weight of the polycarbonate can range from any of the minimum values described above to any of the maximum values described above. For example, the molecular weight of the polycarbonate can be from 500 g/mol to 20,000 g/mol (e.g., from 500 g/mol to 10,000 g/mol, from 1,000 g/mol to 15,000 g/mol; from 1,000 g/mol to 10,000 g/mol; from 2,000 g/mol to 10,000 g/mol; from 2,000 g/mol to 8,000 g/mol; or from 2,000 g/mol to 6,000 g/mol).

As described herein, the sacrificial polymer can include an epoxy functional group and optionally a crosslinker. Accordingly, the polycarbonate sacrificial polymer can have a structure represented by Formula I-A:

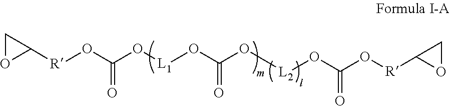

wherein L₁ and L₂ are as described herein;

R′ independently for each occurrence represent substituted or unsubstituted linear and branched C₁ to C₄₀-alkyl, substituted or unsubstituted linear and branched C₂ to C₄₀-alkenyl, substituted or unsubstituted C₆ to C₄₀-cycloalkyl, substituted or unsubstituted C₆ to C₄₀-heterocycloalkyl, substituted or unsubstituted C₆ to C₄₀-cycloalkenyl, substituted or unsubstituted C₆ to C₄₀-aryl, substituted or unsubstituted C₆ to C₄₀-heteroaryl; and

l and m are as described herein.

In some embodiments of Formula I-A, L₁ and L₂ independently represent substituted or unsubstituted linear and branched C₁ to C₁₀-alkyl, substituted or unsubstituted linear and branched C₂ to C₁₀-alkenyl, substituted or unsubstituted linear and branched C₂ to C₁₀-alkynyl, substituted or unsubstituted C₆ to C₂₀-cycloalkyl, substituted or unsubstituted C₆ to C₂₀-heterocycloalkyl, substituted or unsubstituted C₆ to C₂₀-cycloalkenyl, substituted or unsubstituted C₆ to C₂₀-aryl, substituted or unsubstituted C₆ to C₂₀-heteroaryl;

R′ independently for each occurrence represent substituted or unsubstituted linear and branched C₁ to C₁₀-alkyl, substituted or unsubstituted linear and branched C₂ to C₁₀-alkenyl, substituted or unsubstituted C₆ to C₂₀-cycloalkyl, substituted or unsubstituted C₆ to C₂₀-heterocycloalkyl, substituted or unsubstituted C₆ to C₂₀-cycloalkenyl, substituted or unsubstituted C₆ to C₂₀-aryl, substituted or unsubstituted C₆ to C₂₀-heteroaryl; and

l and m independently are integers from 0 to 10,000, wherein the sum of l and m is at least 1.

In some embodiments of Formula I-A, R′ independently for each occurrence represent an alkyl group of 1 to 10 carbon atoms, such as methyl, ethyl, n-propyl, isopropyl, n-butyl, isobutyl, t-butyl, pentyl, hexyl, heptyl, octyl, nonyl, decyl, and the like.

Polyaldehyde

In some embodiments, the sacrificial polymer can include a polyaldehyde compound. The polyaldehyde can include aldehyde units as represented by the formula

—R—CH—O—,

where R is as defined herein.

In certain aspects, the polyaldehyde sacrificial polymer can comprise any one or any combination of the following repeating units:

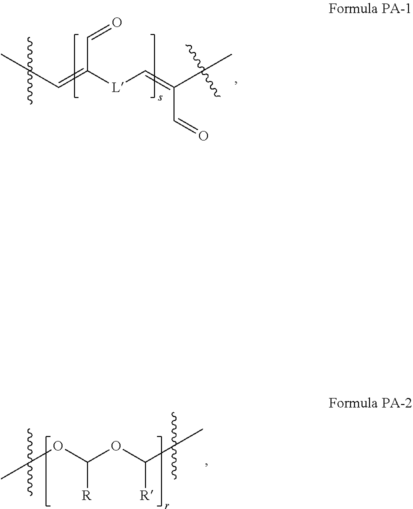

wherein R and R′ can be the same or different;

R can be chosen from C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R can be substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, or amino;

R′ can be chosen from substituted or unsubstituted C₁-C₂₀ alkyl, C₁-C₂₀ alkoxyl, C₂-C₂₀ alkenyl, C₂-C₂₀ alkynyl, C₆-C₁₀ aryl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, R′ can be substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, amino, or carboxylic acid; or R and R′ in some occurrences combine to form a substituted of unsubstituted 5- to 7-membered heterocyclic ring;

L′ can be chosen from C₁-C₂₀ alkyl, C₁-C₂₀ alkoxyl, C₂-C₂₀ alkenyl, C₂-C₂₀ alkynyl, C₆-C₁₀ heteroaryl, C₃-C₁₀ cycloalkyl, C₃-C₁₀ cycloalkenyl, C₃-C₁₀ heterocycloalkyl, or C₃-C₁₀ heterocycloalkenyl; and, when substituted, L can be substituted with C₁-C₂₀ alkyl, C₁-C₂₀ alkoxy, C₂-C₂₀ alkenyl, C₂-C₂₀ alkynyl, C₆-C₁₀ aryl, C₆-C₁₀ heteroaryl, aldehyde, or amino;

where r can be an integer from 1 to 100,000; and s can be an integer from 1 to 100,000.

In certain examples, the polyaldehyde sacrificial polymer can be derived from substituted or unsubstituted C₁-C₂₀ alkyl aldehyde, C₂-C₂₀ alkenyl aldehyde, C₂-C₂₀ alkynyl aldehyde, C₆-C₁₀ aryl aldehyde, C₆-C₁₀ heteroaryl aldehyde, C₃-C₁₀ cycloalkyl aldehyde, C₃-C₁₀ cycloalkenyl aldehyde, C₃-C₁₀ heterocycloalkyl aldehyde, and C₃-C₁₀ heterocycloalkenyl aldehyde. In particular examples, the polyaldehyde sacrificial polymer can be derived from a C₂-C₁₀ alkyl aldehyde, e.g., propylaldehyde, butylaldehyde, pentylaldehyde, or hexylaldehyde. In specific examples, the polyaldehyde sacrificial polymer can be derived from acetaldehyde, propanal, butanal, pentanal, hexanal, heptanal, octanal, nonanal, decanal, undecanal, propenal, butenal, pentenal, hexenal, heptenal, octenal, nonenal, decenal, undecenal, and any combination thereof.

Polysulfone

In some embodiments, the sacrificial polymer can include a polysulfone compound. The polysulfone compound can be selected from polysulfone per se, polyether sulfone, polyaryl sulfone, polyalkyl sulfone, polyaralkyl sulfones, copolymers thereof, or blends thereof.

Polycarbamate

In some embodiments, the sacrificial polymer can include a polycarbamate compound. The polycarbamate can be acyclic, straight or branched; cyclic and nonaromatic; cyclic and aromatic, or a combination thereof. In some embodiments the polycarbamate comprises one or more acyclic, straight or branched polycarbamates.

Polynorbornene

In some embodiments, the sacrificial polymer can include a cycloolefin compound. For example, the sacrificial polymer can include a bicycloolefin. Representative examples of suitable cycloolefin compounds include a norbomene polymer. By norbomene polymer is meant polycyclic addition homopolymers and copolymers comprising one or more of the following repeating units:

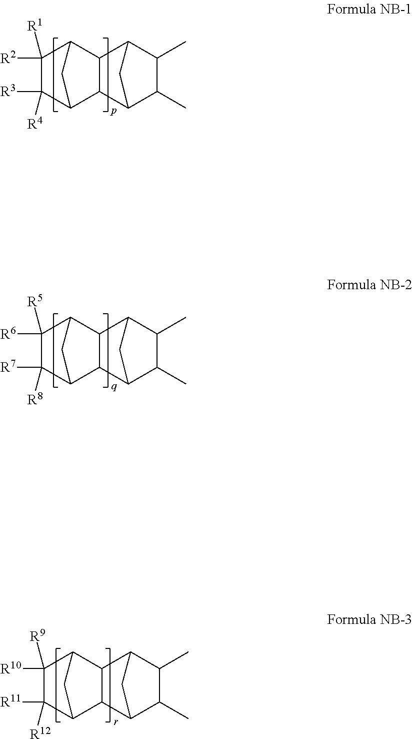

wherein R¹ and R⁴ independently represent hydrogen; linear or branched C₁ to C₂₀ alkyl; R² and R³ independently represent hydrogen, linear or branched C₁ to C₂₀ alkyl or a silane or siloxane group; and m is a number from 0 to 4;

wherein R⁵, R⁶, R⁷, and R⁸ independently represent hydrogen, linear and branched C₁ to C₂₀ alkyl, hydrocarbyl substituted or unsubstituted C₅ to C₁₂ cycloalkyl, hydrocarbyl substituted or unsubstituted C₆ to C₄₀ aryl, hydrocarbyl substituted or unsubstituted C₇ to C₁₅ aralkyl, C₃ to C₂₀ alkynyl, linear and branched C₃ to C₂₀ alkenyl, or vinyl; any of R⁵ and R⁵ or R⁷ and R⁸ can be taken together to form a C₁ to C₁₀ alkylidenyl group, R⁵ and R⁶ when taken with the two ring carbon atoms to which they are attached can represent saturated and unsaturated cyclic groups containing 4 to 12 carbon atoms or an aromatic ring containing 6 to 17 carbon atoms; and p is 0, 1, 2, 3, or 4;

wherein R⁹ to R¹² independently represent a polar substituent selected from the group: -(A)ₙ-C(O)OR″, -(A)ₙ-OR″, -(A)ₙ-OC(O)R″, -(A)ₙ-OC(O)OR″, -(A)ₙ-C(O)R″, -(A)ₙ-OC(O)C(O)OR″, -(A)ₙ-O-A′-C(O)OR″, -(A)ₙ-OC(O)-A′-C(O)OR″, -(A)ₙ-C(O)O-A′-C(O)OR″, -(A)ₙ-C(O)-A′-OR″, -(A)ₙ-C(O)O-A′-OC(O)OR″, -(A)ₙ-C(O)O-A′-O-A′-C(O)OR″, -(A)ₙ-C(O)O-A′-OC(O)C(O)OR″, -(A)ₙ-C(R″)₂CH(R″)(C(O)OR″), and -(A)ₙ-C(R″)₂CH(C(O)OR″)₂; and p is 0, 1, 2, 3, 4, or 5. The moieties A and A′ independently represent a divalent bridging or spacer group selected from divalent hydrocarbon groups, divalent cyclic hydrocarbon groups, divalent oxygen containing groups, and divalent cyclic ethers and cyclic diethers, and n is an integer 0 or 1. Suitable poly(norbornene) sacrificial polymers are described in U.S. Patent Publication No. 2002/0081787 which is incorporated herein by reference in its entirety. One such type of norbonene polymer that is useful as the sacrificial material is sold under the AVATREL™ trademark by The BFGoodrich Company, Akron, Ohio. In some cases, the sacrificial polymer can comprise silyl substituted polynorbornene repeating units.

Polyester

In some embodiments, the sacrificial polymer is a polyester containing repeating units according to the following general formula of:

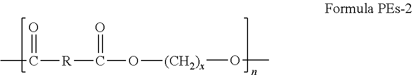

where R represents linear and branched C₁ to C₂₀ alkyl, hydrocarbyl substituted or unsubstituted C₁ to C₁₂ cycloalkyl, hydrocarbyl substituted or unsubstituted C₆ to C₄₀ aryl, hydrocarbyl substituted or unsubstituted C₇ to C₁₅ aralkyl, C₃ to C₂₀ alkynyl, linear and branched C₃ to C₂₀ alkenyl; x is an integer from 1 to about 20; and n is equal to 2 to about 100,000. In certain embodiments, x is an integer from 1 to about 10 and n is equal to 2 to about 10,000. In some examples, x is an integer from 1 to about 6 and n is equal to 2 to about 1,000.

Polyether

In some embodiments, the sacrificial polymer is a polyether containing repeating units according to the following general formula of:

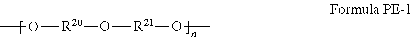

where R²⁰ and R²¹ independently represent linear and branched C₁ to C₂₀) alkyl, hydrocarbyl substituted or unsubstituted C₅ to C₁₂ cycloalkyl, hydrocarbyl substituted or unsubstituted C₆ to C₄₀ aryl, hydrocarbyl substituted or unsubstituted C₇ to C₁₅ aralkyl, C₃ to C₂₀ alkynyl, linear and branched C₃ to C₂₀ alkenyl; and n is equal to 2 to about 100,000. In certain embodiments, n is equal to 2 to about 10,000. In some examples, n is equal to 2 to about 1,000.

Copolymers

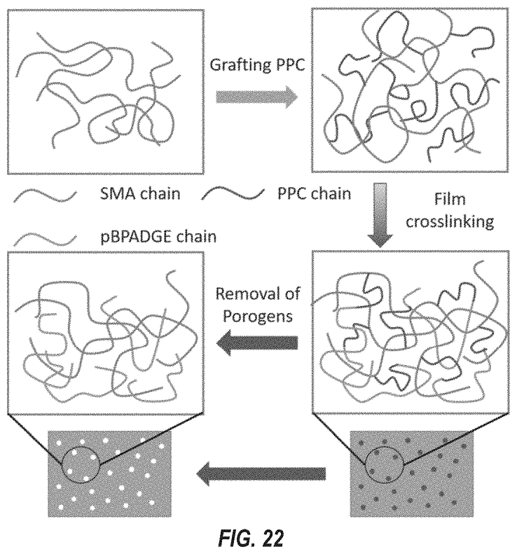

Nanoporous epoxy films derived from copolymers formulated by using sacrificial polymers as a porogen in an epoxy resin formulation are also disclosed herein. The formation of large pores from phase segregation can be mitigated by covalently bonding the sacrificial polymer (porogen material) to a polymer matrix, resulting in a temporary placehold inside the cured polymer film. Thermal decomposition of the sacrificial polymer leads to creation of nanoporous regions inside the film. The copolymers disclosed herein can be crosslinked/entangled after curing, as shown in FIG. 22.

The copolymers can include one or more epoxy resins. For example, the copolymer can include one, two, three, four, five, six, or more epoxy resins. The epoxy resin used in the copolymers can be saturated or unsaturated, aliphatic, cycloaliphatic, aromatic or heterocyclic in nature, or a combination thereof. Additionally, the polyepoxides in the epoxy resin can bear substantially inert substituents, such as alkoxy, halogen, hydroxyl or phosphorus moieties. Examples of epoxy compounds used in the epoxy resin include phenolic epoxy compounds obtained by a condensation reaction of an epihalohydrin compound and a polyhydric phenol compound such as bisphenol A glycidyl ether or the like; alcoholic epoxy compounds obtained by condensation of an epihalohydrin compound and a polyhydric alcohol compound such as hydrogenated bisphenol A glycidyl ether or the like; glycidyl ester-type epoxy compounds obtained by condensation of an epihalohydrin compound and a polyvalent organic acid compound such as 3,4-epoxycyclohexylmethyl-3′,4′-epoxycyclohexane carboxylate, diglycidyl 1,2-hexahydrophthalate, or the like; amine-type epoxy compounds obtained by condensation of a secondary amine compound and an epihalohydrin compound, aliphatic polyvalent epoxy compounds such as vinylcyclohexene diepoxide, and the like.

In certain embodiments, the epoxy resin can include a structure comprising repeating units represented by Formula II:

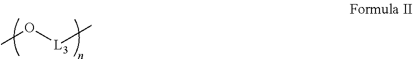

wherein L₃ is selected from substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-aryl, substituted or unsubstituted C₆ to C₂₀-heteroaryl; and n is an integer from 1 to 10,000.

In some embodiments of Formula II, n can be equal to 2 to 10,000, preferably from 2 to 3,000, more preferably from 2 to 1,000, most preferably from 2 to 50.

In certain embodiments, the epoxy resin can be represented by a structure according to Formula II-A:

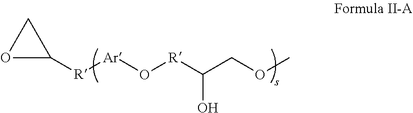

wherein Ar′ includes a substituted or unsubstituted phenyl, substituted or unsubstituted diphenyl methane, substituted or unsubstituted diphenyl ethane, substituted or unsubstituted diphenyl propane, substituted or unsubstituted biphenyl, or substituted or unsubstituted naphthyl.

In some examples, the epoxy resin can be derived from one or more of bisphenol diglycidyl ether, diglycidyl phthalate, diglycidyl adipate, diglycidyl isophthalate, di(2,3-epoxybutyl) adipate, di(2,3 epoxybutyl)oxalate, di(2,3 epoxyhexyl) succinate, di(3,4-epoxybutyl)maleate, di(2,3-epoxyoctyl) pimelate, di(2,3-epoxybutyl)phthalate, di(2,3-epoxyoctyl) tetrahydrophthalate, di(4,5-epoxydodecyl)maleate, di(2,3-epoxybutyl)terephthalate, di(2,3 epoxypentyl)thiodipropionate, di(5,6-epoxytetradecyl)diphenyldicarboxylate, di-(3,4-epoxyheptyl) sulfonyldibutyrate, tri(2,3-epoxybutyl) 1,2,4-b utanetricarboxylate, di 5,6-epoxypentadecyl tartarate, di(4,5-epoxytetradecyl)maleate, di(2,3 epoxybutyl) azelate, di(3,4-epoxybutyl)citrate, di(5,6 epoxyoctyl)cyclohexanel, 3-dicarboxylate, di 4,5-epoxyoctadecyl malonate.

The disclosed copolymers can comprise greater than 30 wt % of the epoxy resin based on the total weight of the copolymer (e.g., 35 wt % or more, 40 wt % or more, 45 wt % or more, 50 wt % or more, 55 wt % or more, 60 wt % or more, 65 wt % or more, 70 wt % or more, 75 wt % or more, or 80 wt % or more). In some examples, the copolymer can comprise 95 wt % or less epoxy resin based on the total weight of the copolymer (e.g., 90 wt % or less, 85 wt % or less, 80 wt % or less, 78 wt % or less, 75 wt % or less, 73 wt % or less, 70 wt % or less, 65 wt % or less, 60 wt % or less, or 55 wt % or less). The amount of epoxy resin in the copolymer can range from any of the minimum values described above to any of the maximum values described above. For example, the copolymer can comprise from greater than 30 wt % to 95 wt % epoxy resin based on the total weight of the copolymer (e.g., from 40 wt % to 95 wt %, from 45 wt % to 85 wt %, from 45 wt % to 80 wt %, from 40 wt % to 75 wt %, or from 45 wt % to 75 wt %).

As disclosed herein, the copolymer can include an epoxy resin and a sacrificial polymer. In certain embodiments, the copolymer can be represented by a structure according to Formula III:

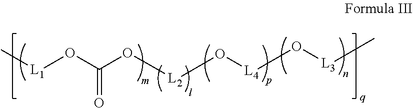

wherein L₁, L₂, and L₃ independently represent substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-aryl, substituted or unsubstituted C₆ to C₂₀-heteroaryl;

L₄ represents a crosslinker;

l is an integer from 0 to 100,000;

m is an integer from 1 to 100,000;

n is an integer from 1 to 100,000;

p is an integer from 0 to 100,000; and

q is an integer from 1 to 100,000.

In some embodiments of Formula III, L₁ and L₂ independently represent substituted or unsubstituted linear and branched C₁ to C₁₀-alkyl, substituted or unsubstituted linear and branched C₂ to C₁₀-alkenyl, substituted or unsubstituted linear and branched C₂ to C₁₀-alkynyl, substituted or unsubstituted C₆ to C₂₀-cycloalkyl, substituted or unsubstituted C₆ to C₂₀-heterocycloalkyl, substituted or unsubstituted C₆ to C₂₀-cycloalkenyl, substituted or unsubstituted C₆ to C₂₀-aryl, substituted or unsubstituted C₆ to C₂₀-heteroaryl;

L₃ represents substituted phenyl, substituted diphenyl methane, substituted diphenyl ethane, substituted diphenyl propane, substituted biphenyl, or substituted naphthyl;

L₄ represents a crosslinker selected from an amine, mercaptan, or anhydride substituted C₁ to C₂₀-alkyl, an amine, mercaptan, or anhydride substituted C₂ to C₂₀-alkenyl, an amine, mercaptan, or anhydride substituted C₂ to C₂₀-alkynyl, an amine, mercaptan, or anhydride substituted C₆ to C₂₀-cycloalkyl, an amine, mercaptan, or anhydride substituted C₆ to C₂₀-aryl, an amine or anhydride substituted C₆ to C₂₀-heteroaryl;

l is an integer from 0 to 10,000, from 0 to 1,000, from 2 to 1,000, or from 2 to 50;

m is an integer from 1 to 10,000, from 1 to 1,000, from 2 to 1,000, or from 2 to 50;

n is an integer from 1 to 10,000, from 4 to 1,000, from 2 to 1,000, or from 2 to 50;

p is an integer from 0 to 10,000, from 0 to 1,000, from 2 to 1,000, or from 2 to 500; and

q is an integer from 1 to 10,000, from 1 to 1,000, from 2 to 1,000, or from 2 to 500.

In some embodiments of Formula III-A, L₁ and L₂ independently for each occurrence represent an alkyl group of 1 to 10 carbon atoms, such as methyl, ethyl, n-propyl, isopropyl, n-butyl, isobutyl, t-butyl, pentyl, hexyl, heptyl, octyl, nonyl, decyl, and the like.

The disclosed copolymers can comprise greater than 0 wt % or more sacrificial polymer based on total weight of the copolymer (e.g., 1 wt % or more, 2 wt % or more, 5 wt % or more, 10 wt % or more, 15 wt % or more, 20 wt % or more, 25 wt % or more, 30 wt % or more, 35 wt % or more, 40 wt % or more, 50 wt % or more, or 60 wt % or more). In some examples, the copolymer can comprise 60 wt % or less sacrificial polymer based on the total weight of the copolymer (e.g., 55 wt % or less, 50 wt % or less, 45 wt % or less, 40 wt % or less, 35 wt % or less, 33 wt % or less, 30 wt % or less, 27 wt % or less, 25 wt % or less, 23 wt % or less, 20 wt % or less, 15 wt % or less, 10 wt % or less, or 5 wt % or less). The amount of sacrificial polymer in the copolymer can range from any of the minimum values described above to any of the maximum values described above. For example, the copolymer can comprise from greater than 0 wt % to 60 wt % sacrificial polymer based on the total weight of the copolymer (e.g., from 1 wt % to 50 wt %, from 1 wt % to 40 wt %, from 5 wt % to 40 wt %, from 2 wt % to 35 wt %, from 5 wt % to 35 wt %, from 1 wt % to 30 wt %, from 2 wt % to 30 wt %, from 5 wt % to 30 wt %, or from 10 wt % to 30 wt %).

As described herein, the copolymers can include a crosslinker. The cross-linker can be used in the copolymers in an amount of from about greater than 0% to about 75% by weight of the copolymer (e.g., 1 wt % or more, 5 wt % or more, 10 wt % or more, 15 wt % or more, 20 wt % or more, 25 wt % or more, 30 wt % or more, 35 wt % or more, 40 wt % or more, 45 wt % or more, 50 wt % or more, 55 wt % or more, 60 wt % or more, 65 wt % or more, or 70 wt % or more,). In some examples, the copolymer can comprise 75 wt % or less crosslinker based on the total weight of the copolymer (e.g., 70 wt % or less, 65 wt % or less, 60 wt % or less, 55 wt % or less, 50 wt % or less, 45 wt % or less, 40 wt % or less, 35 wt % or less, 30 wt % or less, or 25 wt % or less). The amount of crosslinker in the copolymer can range from any of the minimum values described above to any of the maximum values described above. For example, the copolymer can comprise from greater than 0 wt % to 70 wt % crosslinked based on the total weight of the copolymer (e.g., from 1 wt % to 60 wt %, from 5 wt % to 60 wt %, from 5 wt % to 50 wt %, from 5 wt % to 45 wt %, or from 10 wt % to 50 wt %).

Suitable crosslinkers useful with the epoxy resins are described in numerous references such as the Encyclopedia of Poly. Sci. & Eng., “Epoxy Resins” at 348-56 (J. Wiley & Sons 1986). Some of the crosslinkers useful in the present copolymers include, for example, anhydrides such as a carboxylic acid anhydrides, styrene maleic anhydride copolymers, maleic anhydride adducts of methylcyclopentadiene and the like; amino compounds such as dicydiamide, sulfanilamide, 2,4-diamino-6-phenyl-1,3,5 triazine, and the like; carboxylic acids such as salicylic acid, phthalic acid and the like; cyanate esters such as dicyanate of dicyclopentadienyl bisphenol, dicyanate of bisphenol-A and the like; isocyanates such as MDI, TDI and the like; and bismaleic triazines and the like. In certain embodiments, a nitrogen-containing crosslinker can be used. Examples of suitable nitrogen-containing crosslinkers include for example, polyamines, polyamides, sulfanilamide, diaminodiphenylsulfone, and diaminodiphenyl methane and dicyandiamide, substituted dicyandiamide, 2,4-diamino-6-phenyl-1,3,5-triazine. In certain examples, the crosslinker can include copolymers of styrene and maleic anhydride having a molecular weight (Mw) in the range of from 1,500 to 50,000 and an anhydride content of more than 15 percent. Commercial examples of these materials include SMA 1000, SMA 2000, SMA 3000, and SMA 4000, and having molecular weights ranging from 4,000 to 15,000.

Methods of Making

Also disclosed are methods of preparing the epoxidized sacrificial polymers described herein. In certain embodiments, epoxidizing the sacrificial polymer comprises reacting the sacrificial polymer with an epoxide precursor to form a capped sacrificial polymer; and oxidizing the epoxide precursor in the capped sacrificial polymer to form the epoxidized sacrificial polymer. The epoxide precursor refers to a compound used to form the epoxide group on the epoxidized sacrificial polymer, and which can be readily converted to include epoxide groups. For example, an epoxide precursor can include an alkene-containing functional group, for example an allyl-functional group such as allyl chloroformate. The mole ratio of the epoxide precursor and reactive end-groups (such as hydroxyl groups) present in the sacrificial polymer precursor can be 2:1 or greater, such as 5:1 or greater, 10:1 or greater, from 2:1 to 200:1, from 2:1 to 40:1, or from 2:1 to 20:1. The alkene-containing functional group can be oxidized with an organic peroxide, a dioxirane, a metal complex catalyst, ozonolysis, or a photocatalysis oxidizing agent such as Mn-salen catalyst, titanium tetraisopropoxide, tertbutyl hydroperoxide, yttirium-chiral biphenyldiol, m-chloroperoxybenzoic acid, sodium periodate, or hydrogen peroxide.

Other suitable epoxide precursor can include epichlorohydrin. Upon such reaction, the leaving group is removed and an epoxide group is formed. One skilled in the art would recognize that variations of this group can also be used to form an epoxide group. In other embodiments, epoxidizing the sacrificial polymer precursor can include reacting the sacrificial polymer precursor with an epihalohydrin such as epichlorohydrin, epifluorohydrin, or epibromohydrin in the presence of a base. The base can be an alkali metal hydroxide (e.g., aqueous concentrated sodium hydroxide) or an alkali or alkaline earth metal lower alkoxide (e.g., sodium methoxide). The mole ratio of the epihalohydrin and reactive end-groups (such as hydroxyl groups) present in the sacrificial polymer precursor can be 2:1 or greater, such as 5:1 or greater, 10:1 or greater, from 2:1 to 200:1, from 2:1 to 40:1, or from 2:1 to 20:1.

Also disclosed are methods of preparing the copolymers described herein comprising the sacrificial polymer and an epoxy resin. The method of making the copolymer optionally includes grafting the epoxidized sacrificial polymer onto a crosslinker to form a grafted epoxidized sacrificial polymer. As described herein, suitable crosslinkers include amine-containing, mercaptan-containing, or anhydride-containing functional groups. For example, the epoxidized sacrificial polymer can be grafted onto an anhydride-containing crosslinker, such as styrene maleic anhydride by ring opening the maleic anhydride catalyzed by a tertiary amine or imidazole, such as 2-ethyl-4-methylimidazole. The nitrogen atom on imidazole molecule acts as the base that can deprotonate the α-hydrogen on anhydride ring, leading to the accelerated ring-opening process at elevated temperature. Adding too much imidazole can cause the undesired dielectric loss increase due to the polarity of N-H bond. In this case, 0.5 wt % or less of 2-ethyl-4-methylimidazole with respect to the solid content can be added.

The amount of sacrificial polymer grafted onto the crosslinker can vary depending on the intended purpose of the copolymer. For example, the sacrificial polymer can be present in an amount of greater than 0 wt % based on total weight of the sacrificial polymer and crosslinker (e.g., 1 wt % or more, 5 wt % or more, 10 wt % or more, 15 wt % or more, 20 wt % or more, 25 wt % or more, 30 wt % or more, 35 wt % or more, or 40 wt % or more). In some examples, 50 wt % or less sacrificial polymer can be grafted on the crosslinker, based on the total weight of the sacrificial polymer and crosslinker (e.g., 45 wt % or less, 40 wt % or less, 35 wt % or less, 30 wt % or less, 25 wt % or less, 20 wt % or less, 15 wt % or less, or 10 wt % or less). The amount of sacrificial polymer grafted on the crosslinker can range from any of the minimum values described above to any of the maximum values described above. For example, from greater than 0 wt % to 50 wt % of the sacrificial polymer can be grafted on the crosslinker based on the total weight of the sacrificial polymer and crosslinker (e.g., from 1 wt % to 45 wt %, from 1 wt % to 40 wt %, from 5 wt % to 35 wt %, from 5 wt % to 30 wt %, from 10 wt % to 30 wt %, or from 10 wt % to 25 wt %).

The reaction between the sacrificial polymer and crosslinker can be carried out by under reflux conditions. In some embodiments, the reaction temperature can be from 70° C. to 110° C. and the reaction continued for at least 24 hours (e.g., at least 2 days, at least 4 days, or at least 6 days). The resulting product can be precipitated at room temperature in a solvent such as methanol and the product separated by filtration and air-dried.

The method of making the copolymer can include blending the expoxidized sacrificial polymer or the grafted epoxidized sacrificial polymer, an epoxy resin, and a solvent to form a solution. Suitable solvents can include polar organic solvents such as methyl ethyl ketone. The solution can include the blend of expoxidized sacrificial polymer or grafted epoxidized sacrificial polymer and the epoxy resin in weight fractions of greater than 0 wt % (e.g., 5 wt % or greater, 10 wt % or 20 wt % or greater) based on the total mass of the solution.

The method of making the copolymer can include curing the solution comprising the epoxidized sacrificial polymer or grafted epoxidized sacrificial polymer and the epoxy resin to form the copolymer. For example, the method can include coating the solution, such as by spin coating onto a silicon wafer. The silicon wafer can be coated with a metal such as titanium prior to coating with the solution. The solution can be spin coated at a ramp rate of 1500 rpm to a speed of 1500 rpm for 10 seconds. The solution can then be cured to form a film by soft baking at a suitable temperature for a period of time, such as at 50° C. for 1 min, followed by 75° C. for 18 hr to begin the epoxy-crosslinker reaction. The temperature can then be increased to decompose the sacrificial polymer. The decomposition temperature should be compatible with the various components of the film so as not to destroy the integrity thereof aside from the removal of the sacrificial material to form the pores. Typically, such temperature should be less than about 450° C.

For propylene carbonate sacrificial polymers, the decomposition mechanism can be either chain end unzipping, which normally takes place at around 180° C., or chain scission, which normally takes place at higher temperature, 200° C. Chain end unzipping mechanism generates propylene carbonate, while chain scission mechanism generated carbon dioxide and acetone. End capping of propylene carbonate can be used to stabilize the propylene carbonate at higher temperature for wider processing window. Owing to the hydroxyl functionality at its chain ends, propylene carbonate can be easily functionalized using S_{N}2 nucleophilic substitution to create functionalized end group. This reaction can take place at room temperature due to its exothermic nature. End capping propylene carbonate suppresses the generation of less volatile propylene carbonate caused by chain end unzipping and promote the random chain scission mechanism to create more volatile chemicals. The decomposition temperature of propylene carbonate fit well with epoxy resin. The decomposition temperature is high enough for epoxy to crosslink, while it is also low enough that propylene carbonate can be removed before phase change and degradation of epoxy resin matrix occur.

In some embodiments, the method can include curing the epoxy resin at a temperature of about 180° C. for 6 hr to decompose the sacrificial polymer. However, the decomposition temperature will vary based on the specific sacrificial polymer used. Finally, the epoxy resin can be fully cured at about 220° C. for 10 min to ensure complete decomposition of the polycarbonate sacrificial polymer and to complete the epoxy curing.

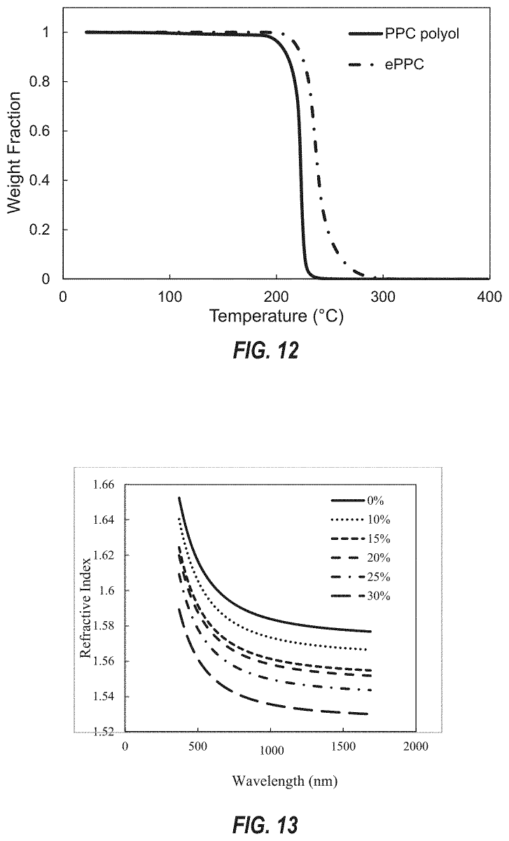

The epoxide polypropylene carbonate also has a decomposition temperature that falls within the processing window of epoxy resin, as shown in FIG. 12. The stabilization of epoxide end group is demonstrated by the thermogravimetric analysis (TGA), where the decomposition temperature was elevated by 20° C. to 200° C. This indicates that the main decomposition mechanism of epoxide polypropylene carbonate will be through the random chain scission. The chain scission mechanism will generate more volatile chemicals.

With regard to the sacrificial polymer materials, it has been found that by incorporating a photo-activated compound (e.g., a photoacid generator (PAG) or a photobase generator (PBG)) or a thermal-activated compound (e.g., thermal acid generator (TAG)), the decomposition temperatures of the sacrificial polymers can be significantly lowered. For example, the decomposition temperature of the polycarbonates (approximately 180° C.) can be lowered by up to 90° C. by incorporating a TAG or PAG component. The thermal acid generators (TAGs) for use herein can be polymeric or non-polymeric. Exemplary TAGs include ionic thermal acid generators, such as sulfonate salts, including fluorinated sulfonate salts. Suitable salts include ammonium salts, for example ammonium triflate; ammonium perfluorobutanesulfonate (PFBuS); ammonium Ad-TFBS [4-adamantanecarboxyl-1,1,2,2-tetrafluorobutane sulfonate]; ammonium AdOH-TFBS [3-hydroxy-4-adamantanecarboxyl-1,1,2,2-tetrafluorobutane sulfonate]; or ammonium Ad-DFMS [Adamantanyl-methoxycarbonyl)-difluoromethanesulfonate]. The thermal acid generator produces an acid having a pKa of less than about 2 (or less than about 1, or less than about 0) upon thermal treatment. The pKa of the acid generated by a TAG may be known or can be determined by conventional methods (e.g., determination of the pKa in an aqueous solution).

Suitable PAGs are known in the art and include, for example onium salts, for example, triphenylsulfonium trifluoromethanesulfonate, (p-tert-butoxyphenyl)diphenylsulfonium trifluoromethanesulfonate, tris(p-tert-butoxyphenyl)sulfonium trifluoromethanesulfonate, triphenylsulfonium p-toluenesulfonate; nitrobenzyl derivatives, for example, 2-nitrobenzyl-p-toluenesulfonate, 2,6-dinitrobenzyl-p-toluenesulfonate, and 2,4-dinitrobenzyl-p-toluenesulfonate; sulfonic acid esters, for example, 1,2,3-tris(methanesulfonyloxy)benzene, 1,2,3-tris(trifluoromethanesulfonyloxy)benzene, and 1,2,3-tris(p-toluenesulfonyloxy)benzene; diazomethane derivatives, for example, bis(benzenesulfonyl)diazomethane, bis(p-toluenesulfonyl)diazomethane; glyoxime derivatives, for example, bis-O-(p-toluenesulfonyl)-α-dimethylglyoxime, and bis-O-(n-butanesulfonyl)-α-dimethylglyoxime; sulfonic acid ester derivatives of an N-hydroxyimide compound, for example, N-hydroxysuccinimide methanesulfonic acid ester, N-hydroxysuccinimide trifluoromethanesulfonic acid ester; and halogen-containing triazine compounds, for example, 2-(4-methoxyphenyl)-4,6-bis(trichloromethyl)-1,3,5-triazine, and 2-(4-methoxynaphthyl)-4,6-bis(trichloromethyl)-1,3,5-triazine.

The rate of decomposition should be slow enough so that diffusion through the film will occur. Diffusion typically arises from a pressure buildup within the air gap. This pressure build up should not be so great as to exceed the mechanical strength of the film. Increased temperature will generally aid diffusion as diffusivity of gas though the film will normally increase with temperature. In some embodiments, the sacrificial material is decomposed at a relatively slow rate. In one embodiment, the heating rate is between about 0.5 to about 10° C./minute. In another embodiment, the heating rate is between about 1 to about 5° C./minute. In yet another embodiment, the heating rate is between about 2 to about 3° C./minute.

As will be appreciated, the air gaps may contain residual gas although generally the residual gas will eventually exchange with air. However, steps may be taken to prevent such exchange, or dispose a different gas (a noble or inert gas for example) or a vacuum in the air gaps. For example, the porous film may be subjected to vacuum conditions to extract any residual gas from the air gaps by diffusion or other passage through the overcoat layer or otherwise, after which the porous film may be coated by a suitable sealing material blocking any further passage of gases through the overcoat layer. Before the porous film is sealed, it may be subjected to a controlled gas atmosphere, such as one containing an inert gas (e.g., nitrogen), to fill the air gaps with such gas.

In some embodiments, the porous film can be subjected to the necessary decomposition temperature while contained in an atmosphere which will enable exchange or absorption of one or more molecules into the air gaps formed during decomposition. For example, the porous film can be subjected to decomposition in an oxygen atmosphere or a SiH₄. An oxygen atmosphere will, for example, yield hydrophilic air gaps.

Means other than high temperature can be used for decomposing the sacrificial polymer. For example, the sacrificial polymer can be removed by a solvent, such as an acid.

The cured films can be further treated with a hydrophobic compound to coat any exposed hydrophilic groups in the film. For example, the cured films can be immersed in hexamethyldisilazane (HMDS) vapor to hydrophobically treat the exposed hydrophilic groups. Silane head group typically has low polarizability, which can help with mitigating dielectric loss of the porous epoxy film. Hydrophilic group could appear inside the wall of the pores due to the epoxy crosslinking and sacrificial polymer decomposition. Typical hydrophilic groups for polycarbonate sacrificial polymers are hydroxyl groups. HMDS could diffuse into the film and pores due to its small molecule size and react with the hydroxyl groups. There are two steps of nucleophilic substitution for each HMDS molecule with hydroxyl group to cover the hydrophilic group exposed inside the pore. HMDS has several advantage over other silane molecules. It contains symmetric silane group that can react with two hydroxyl group, and it generate volatile NH₃ gas that can leave the film without traces behind.

The films formed from the copolymers after decomposition of the sacrificial polymer as described herein are porous. The porous films have a cellular structure, wherein a majority of the cells are closed. The properties of the porous films (e.g., density, modulus, tensile strength, and so forth) can be adjusted by varying the components of the copolymer as is known in the art.

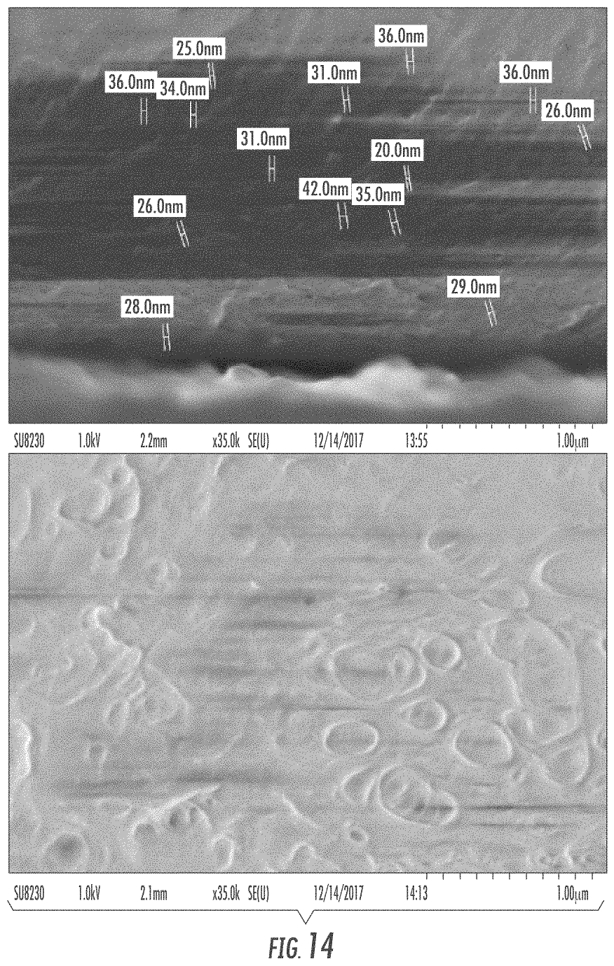

The porous films can comprises a plurality of disconnected pores or a combination of disconnected and connected pores. In some examples, the pores can be substantially disconnected. “Disconnected pores,” also referred to herein as “closed pores,” refer to pores comprising a membrane surrounding a cavity that is intact and not perforated. “Connected pores,” also referred to herein as “open pores,” refer to poress that are joined/connected with each other, and substantially extend from a surface of the support layer to an inner portion of the support layer. The appearance of pores inside the film can be determined using an ellipsometer to measure the refractive index. Due to the transparency of the epoxy film, a Cauchy equation model could be used to fit in the experimental data. With the increase of the porosity, the refractive index should decrease. FIG. 13 shows the refractive index for various films with different porosity. With the increase of the porosity, the refractive index decreases.

The porous film can comprise pores with an average diameter of about 1 micron or less. For example, the porous film can comprise pores with an average diameter 750 nm or less, 500 nm or less, 400 nm or less, 350 nm or less, 300 nm or less, 250 nm or less, 200 nm or less, 150 nm or less, 120 nm or less, 110 nm or less, 100 nm or less, 90 nm or less, 80 nm or less, or 75 nm or less. In certain embodiments, the pores can have an average diameter of from greater than 1 nm to 1 micron, from 5 nm to 500 nm, from 10 nm to 500 nm, from 25 nm to 500 nm, from 5 nm to 200 nm, from 5 nm to 150 nm, from 5 nm to 100 nm, from 10 nm to 100 nm, or from 25 nm to 100 nm.

The porous films can have a void volume (also referred to herein as pore volume) of greater than 0% (e.g., from greater than 0% to 50%, from 1% to 50% or from 5% to 40%), based on the total volume of the film.

The porous films can have a hardness of 0.15 gigapascals (GPa) or more (e.g., 0.17 GPa or more, 0.2 GPa or more, 0.25 GPa or more, or 0.3 GPa or more). In some examples, the disclosed porous films can have a hardness of from 0.15 GPa to 0.50 GPa (e.g., from 0.15 GPa to 0.3 GPa, or from 0.15 GPa to 0.25 GPa). In some examples, the disclosed porous films can have a young modulus of 6 GPa or more, e.g., 7 GPa or more, 7.5 GPa or more, or 8 GPa or more. In some examples, the disclosed porous films can have a young modulus of from 6 GPa to 10 GPa, or from 7 GPa to 9 GPa. FIGS. 15 and 17 shows the reduced modulus and hardness of the film made using 2 kDa epoxide polypropylene carbonate with styrene maleic anhydride crosslinker. For films made out of styrene maleic anhydride crosslinker, with porosity up to 25% both hardness and reduced modulus were not significantly affected, around 4 GPa for reduced modulus and 0.2 GPa for hardness. The converted young modulus is around 8 GPa, which lies in the range of a fully cured epoxy resin.

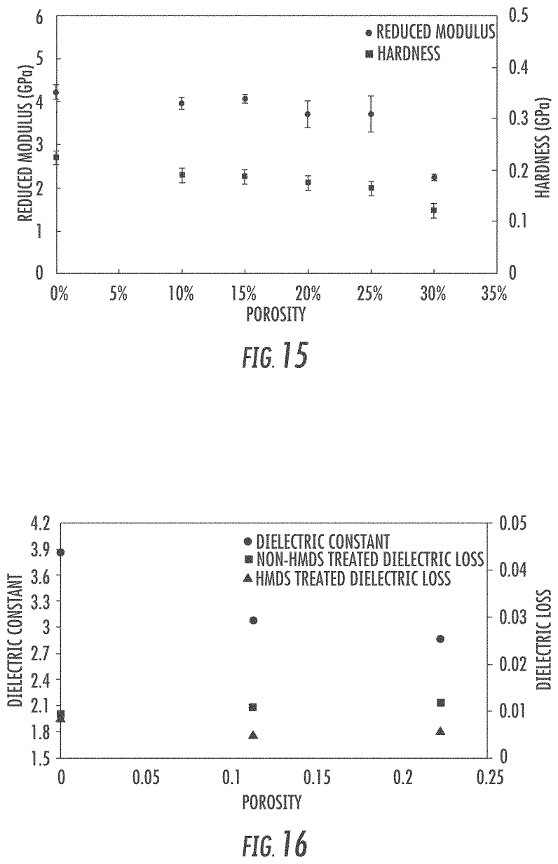

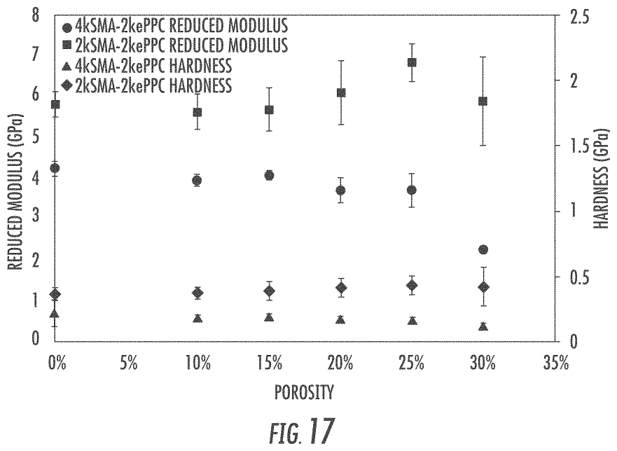

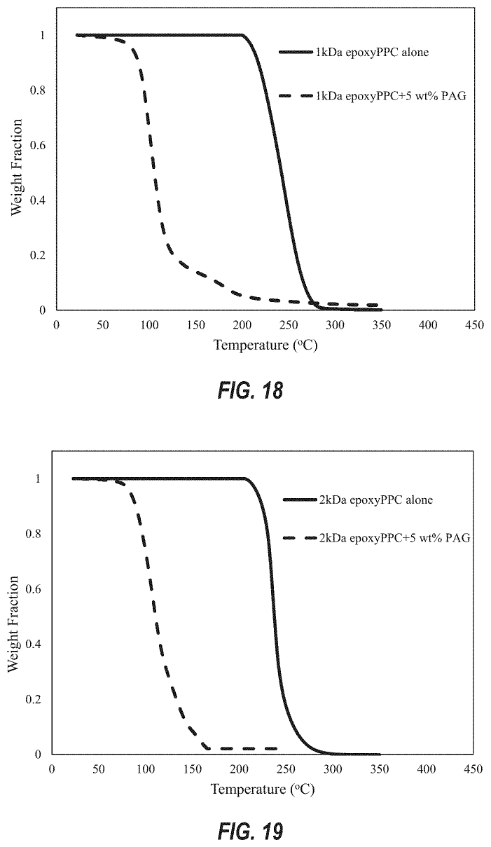

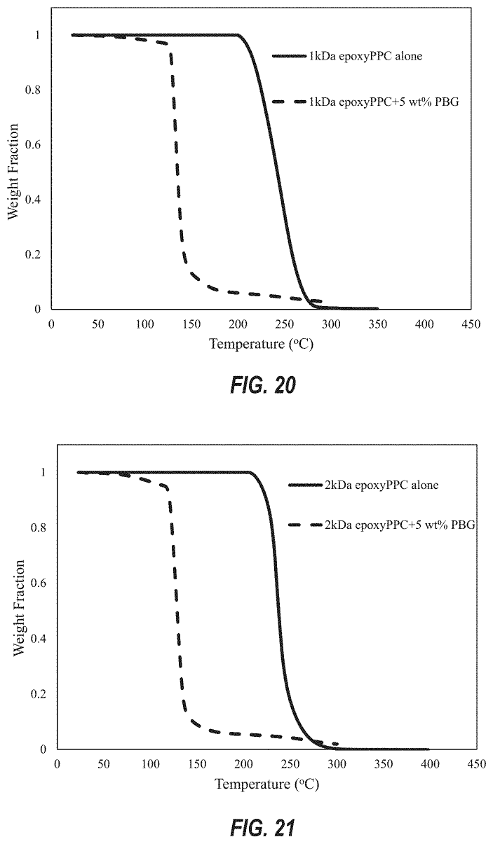

The porous film can have dielectric constant of less than 3.5 (e.g., less than 3.3, less than 3.2, less than 3.1, less than 3.0, less than 2.9, or less than 2.8). In certain embodiments, the dielectric constant of the porous film can be from 2.5 to 3.5 (e.g., from 2.7 to 3.3 or from 2.7 to 3.0). FIG. 16 shows the dielectric constant of the film at porosity of 0%, 11.3%, and 22.3%. The original epoxy resin used has dielectric constant at 3.865. With the addition of 22.3% pore volume inside the film, the dielectric constant drops to 2.864. The dielectric constant of the porous films can be determined by sandwiching the film between two layers of aluminum to create a capacitor structure to measure dielectric properties. The bottom aluminum layer is evaporated onto silicon wafer, while the top aluminum metal is deposited using shadow mask with designated surface area. The dielectric properties are measured using an LCR meter, with frequency set to maximum of the tool at 200 kHz and voltage also at maximum at 1.275 V.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Example 1: Grafted Epoxide Functionalized Polypropylene Carbonate Porogen for Low Dielectric Constant Epoxy Films

This example relates to a significant decrease in dielectric constant (permittivity and loss) of FR4 epoxy resin dielectric through the creating of closed-pores within the crosslinked epoxy resin. The pores are created by modifying the epoxy starting material (epoxy monomers or oligomers, such as bis-phenol-A diglycidyl ether) with a sacrificial, pore-creating compound, or porogen. The porogen is bonded to the epoxy monomer or oligomer so that it remains well dispersed and does not agglomerate into large pores. Upon heating, the epoxy resin cures into a thermoset material and the porogen decomposes into gaseous products. The gaseous products permeate through the fully dense portions of the polymer network leaving closed pores. Polypropylene carbonate (PPC) is one example of a porogen. The PPC was modified by terminating it with an epoxy functionality at both ends. The epoxy terminated PPC can then react and cure with the other epoxy monomers or oligomers (e.g. bis-phenol-A-diglycidyl ether) to form a polymer network. During the curing reaction of the epoxy, PPC decomposes to a gas leaving a closed pore FR4 composition.

Experiments were performed to modify the PPC so that it is terminated by a glycidyl ether by reacting the hydroxyl ends of PPC with allyl chloroformate to yield an allyl terminated PPC molecule. The allyl ends of the PPC were then chemically transformed into epoxide rings by reaction of the allyl ends of the PPC with MCPBA (meta chloro peroxi benzoic acid). The epoxy terminated PPC was then mixed with a typical FR4 epoxy resin formulation and cured by heating to 180° C. A cross section of the resulting FR4 resin was examined in a scanning electron microscope. Pores of about 100 nm diameter or smaller observed.

A second method of terminating the PPC with was investigated. The PPC was reacted with epichlorohydrin. A 3 gram sample of a 2 kDa MW polypropylene carbonate (PPC) polyol having about 0.003 moles of free hydroxyl end groups was dissolved in 4.51 grams of epichlorohydrin. This amount corresponds to an excess of 15:1 molar ratio of epichlorohydrin to hydroxyl end-group of PPC. Two drops of a pH indicator (phenolthaelin) were dropped into the vial. An amount of 1.60 grams of another formulation of 30 (w/w) % of sodium hydroxide in deionized water was added slowly to the reaction vial over the course of 1 hour. A white precipitate of sodium chloride formed at the bottom of the vial which is a visual indicator that the reaction is underway. The reaction was left to run for 12 hours at 60° C. The reaction temperature was raised to 115° C. for 15 minutes (or until no more mass is loss from the vial) to evaporate all excess epichlorohydrin solvent. The resulting transparent, viscous liquid is approximately 3 grams of 2 kDa PPC end-capped with an epoxy group.

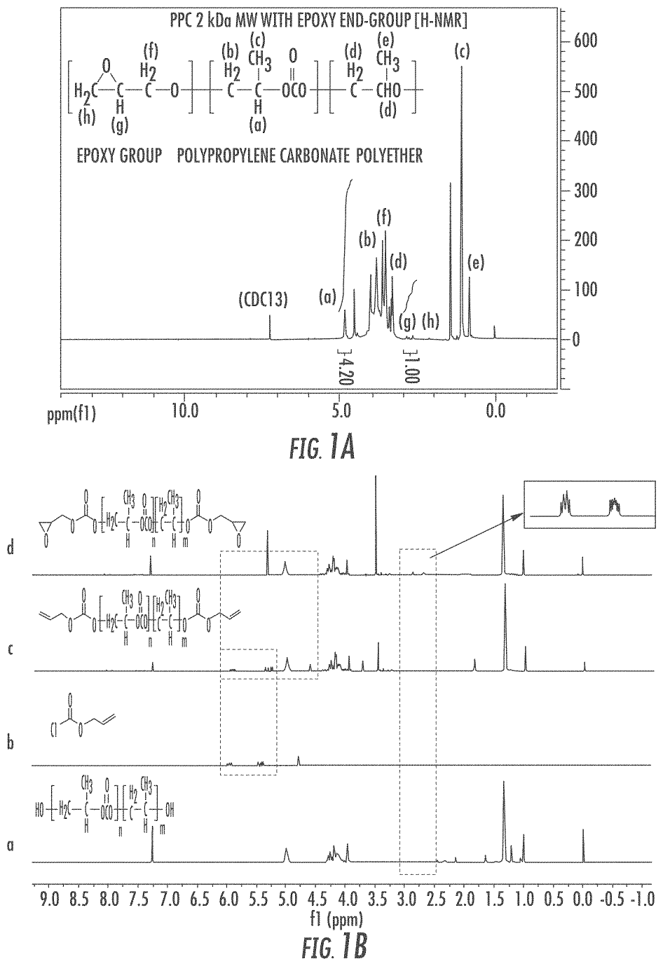

Quantitative characterization of the molar ratio of the end-groups to the polymer chain ends can be determined from integration of ¹H NMR peaks as shown in FIG. 1A. Peaks (a)-(e) confirm the existence of alternating carbonate backbone of PPC. Peaks (f)-(h) reveal the peaks of the epoxy end-groups. Peaks (g) and (h) are the clearest signals in the spectra from the epoxy. The number-average molecular weight of the PPC is 1818.18 g/mol. This corresponds to a monomer to end-group ratio of 8.91:1. The integration of the PPC backbone Peak (a) was compared to integration of the protons from the end-cap Peak (f) and Peak (g). Integration of Peak (a) shows an area of 4.2 which is normalized to protons from two different sites on the epoxy end-group. Thus, the ratio of monomer to end-group is 8.4:1. This value is very close to the number of monomers per end-groups (8.91:1) and within expected experimental error. These results reveal that end-capping PPC with an epoxy has been achieved.

The di-glycidyl ether PPC can then be cured with traditional FR4 epoxy resins, creating closed pores within the epoxy matrix.

### Experimental

Materials:

PPC polyol with molecular weight of 2 kDa was supplied by Novomer Inc. Catalyst 2-ethyl-4-methylimidazole (2E4MI) was obtained from Momentive Specialty Chemicals. Styrene Maleic Anhydride (SMA, Mw=9090 g/mol), with styrene to maleic anhydride ratio of 4:1, was provided by Yuan Hong Corporation. Poly(bisphenol A diglycidyl ether) (pBPADGE, Mw=1750 g/mol), allyl chloroformate and 3-chloroperbenzoic acid (m-CPBA, ≤77%) were purchased from Sigma-Aldrich. Tetrahydrofuran (THF), dichloromethane (DCM) and methanol solvent were all purchased from BDH, at purity level >99%. Methyl ethyl ketone solvent (MEK, >99%) was purchased from Fisher Scientific. Pyridine (>99%) and chloroform-d (CDCl₃, >99.8%) were purchased from Alfa Aesar. All chemicals were used as received.

Epoxidation of PPC Polyol:

Scheme 1 shows the reaction procedure that yields the desired grafting product. The epoxide form of PPC (ePPC) was synthesized by dissolving 20 wt % PPC polyol in THF.

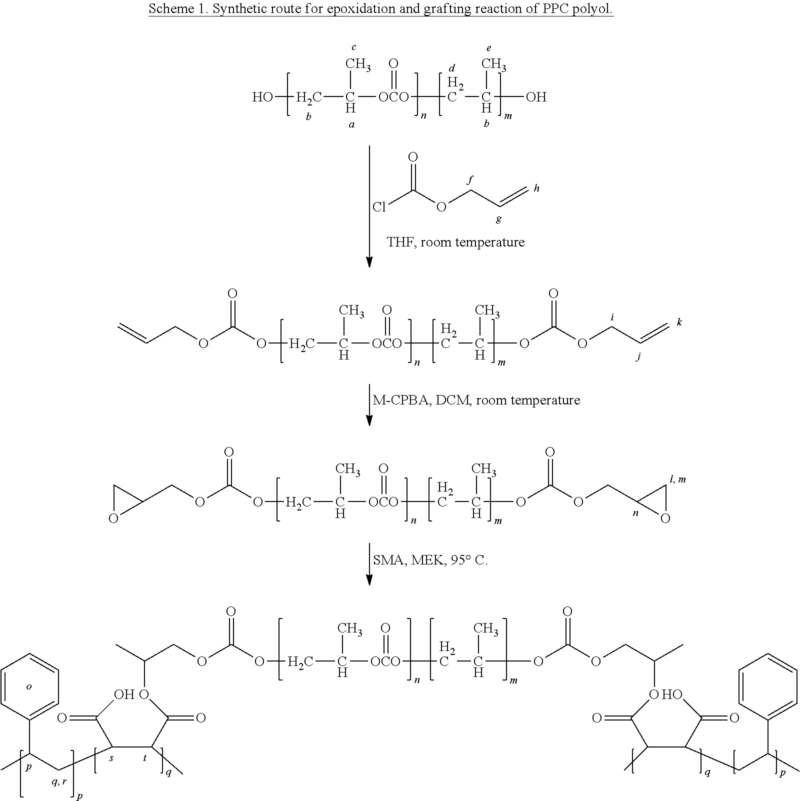

Five eq. of end capping reagent, allyl chloroformate and 5 eq. of pyridine were added dropwise to the dissolved PPC polyol at 5° C. and stirred for 2 hr. The mixture was brought to room temperature and stirred for 3 days to complete the reaction. The by-product pyridinium-chloride salt was filtered and the resulting functionalized polymer allyl PPC (aPPC) was precipitated in the cold methanol, followed by drying in vacuum oven at 100° C. for 3 hr.

Epoxidation was finished by dissolving 20 wt % aPPC in DCM. 10 eq. of m-CPBA was added to the dissolved aPPC and mixed. Continuous stirring was performed for four days at 25° C. to form ePPC. The ePPC was precipitated in cold methanol, and air dried.

Grafting Copolymerization:

The ePPC was grafted onto the SMA by ring opening the SMA maleic anhydride catalyzed by a tertiary amine 2E4MI. 10%, 20%, 30% and 50% weight fractions of grafted ePPC were prepared. The SMA was dissolved in the MEK and 1 wt % 2E4MI catalyst with respect to ePPC was added. The reaction was then refluxed at 95° C. for 6 days. The resulting product SMA-g-PPCx was precipitated at room temperature in the methanol and the product was separated by filtration and air-dried. The x in SMA-g-PPCx is the weight fraction of ePPC in the copolymer (e.g., 10% weight ePPC in SMA-g-PPCx is SMA-g-PPC0.1).

Preparation of Epoxy Resin Solution:

The porous epoxy resin mixture was made by mixing 0.3 g of pBPADGE with SMA-g-PPCx, where the amount of SMA corresponded to 0.4 g within the SMAg-PPCx. Mixtures where made corresponding to weight fractions of 0%, 5%, 13% and 20% ePPC within the total mass. MEK was used as the solvent. The mixture was sonicated at room temperature.

Film Formulation:

Silicon wafers were cleaned using acetone and dried in a nitrogen stream. CHA Modified Mark-40 E-beam evaporator was used to deposit metal films at a pressure below 10-5 torr. Titanium was deposited at the rate of 1 Å/s to a thickness of 30 nm followed by aluminum (99.99% pure), 800 nm thick, at a rate of 2 Å/s. The pBPADGE/SMA-g-PPCx solution was spin coated onto the silicon at a ramp rate of 1500 rpm to a speed of 1500 rpm for 10 seconds. The films were cured by first soft baking at 50° C. for 1 min, followed by 75° C. for 18 hr to begin the pBPADGE-SMA reaction and 180° C. for 6 hr to decompose the PPC. Finally, the pBPADGE was fully cured at 220° C. for 10 min to ensure complete PPC decomposition and to complete the epoxy curing. A 300 nm top layer of aluminum was deposited at 2 Å/s by evaporation on the cured polymer film for capacitance measurements.

Characterization:

The ePPC synthesis (i.e., aPPC, ePPC, and SMA-g-PPCx) was characterized by ¹H NMR using a Varian Mercury Vx 400 (400 MHz) spectrometer before and after the functionalization PPC polyol using chloroform-D as the solvent. 0.5 mg of polymer was dissolved in 0.75 ml of chloroform-D for the ¹H NMR analysis using 32 scans with relaxation time of 1 s. The CDCl₃ peak was calibrated at 7.26 ppm.

Differential scanning calorimetry (DSC) was performed (TA InstrumentsQ20) to examine the T_{g} of the crosslinked polymer film. The film was sealed in a platinum pan and ramped at a rate of 10° C./min to 200° C. Thermogravimetric analysis (TGA) was performed (TA Instruments Q50) to investigate the PPC decomposition temperature and weight fraction in the formulation. The platinum pan was cleaned in acetone and re-zeroed before each run. PPC polyol, aPPC and ePPC were ramped at rate of 5° C./min to 400° C. The SMA-g-PPCx and formulated polymer films were ramped at 5° C./min to 500° C.

The capacitance and tangent loss of the epoxy films were measured with a GWinstek LCR-821 meter. At least five capacitors with an electrode area of 0.065 cm² were measured for each data point. The frequency was controlled at 200 kHz and bias was set to 1.275 V. The dielectric constant was calculated based on ε=Cd/(Aε₀), where C is the capacitance, co is the vacuum permittivity (8.85*10⁻¹²F/m), A is the area of the smaller electrode, and d is the dielectric thickness.

An Hitachi SU8230 scanning electron microscope (SEM) was used to image cross-sections of the polymer film. The SEM was operated at 1 kV with emission current of 5 mA. Nitrogen absorption isotherms of the films were measured at 77 K on a Quadrasorb system from Quantachrome Instruments.

The reduced modulus and hardness of the spin-casted films were determined using a Hysitron Triboindenter with a 1 μm diameter conical tip. The indent depth was less than 10% of the film thickness. The indent depth for the 0%, 5%, 13% and 20% porogen samples was 67 nm, 79 nm, 98 nm, and 56 nm, respectively. A polycarbonate sample was used as the reference to calibrate the projected area coefficient. 4-point data were obtained between 50 μN to 200 μN with an interval of 50 μN to avoid substrate effects. The reduced modulus of the film can be determined using Equation 1.

Eᵣ=√π/2βdP/dh/√A [1]

In Eq. 1, Eᵣ is the reduced modulus of the material tested, β is a geometric constant on the order of unity, dP/dh is the slope of the linear portion of the unloading curve, and A is the projected area of the indentation.

Functionalization of PPC Polyol:

The first step in the modification of PPC was to react the hydroxyl free-ends with the allyl chloroformate via S_{N}2 nucleophilic substitution forming aPPC. The aPPC was then functionalized to ePPC by Prilezhaev epoxidation as described in the experimental section. The ¹H NMR spectrum for the PPC polyol and its subsequent functionalized products are shown in the FIG. 1B. FIG. 1B, spectrum a shows the ¹H NMR of PPC polyol. The molecular weight of ePPC was calculated using end group analysis based on ¹H NMR spectrum. Integration of peaks at 4.92-5.02 ppm and peaks at 2.65 ppm-2.70 ppm gives a ratio of 27.16 of PPC repeat units to the epoxide ring on both ends, which corresponds to a molecular weight of 3 kDa for ePPC.

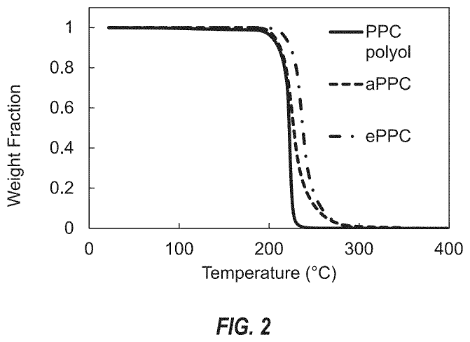

The TGA of PPC polyol, aPPC and ePPC are shown in FIG. 2. PPC polyol decomposes by two mechanisms, end-unzipping (or sometimes called backbiting) which occurs first at a lower temperature, and random chain scission which usually occurs at a higher temperature (Phillips, et al., “Thermal Decomposition of Poly(propylene Carbonate): End-Capping, Additives, and Solvent Effects,” Polym. Degrad. Stab., 125:129 (2016)). The onset of thermal degradation of aPPC was similar to that of PPC polyol. However, the degradation process was completed at a slightly higher temperature because the allyl chloroformate stabilized the ends of the PPC polyol. This forced the reaction to occur more through random chain scission, leading to a higher temperature process. The thermal degradation of ePPC also occurred at a slightly higher temperature than PPC polyol because of the suppression of the end-group unzipping reaction. Complete decomposition of ePPC occurred at a higher temperature than PPC polyol due to the stabilization of the end group, forcing the random chain scission to dominate.

Synthesis and Characterization of SMA-g-PPCx:

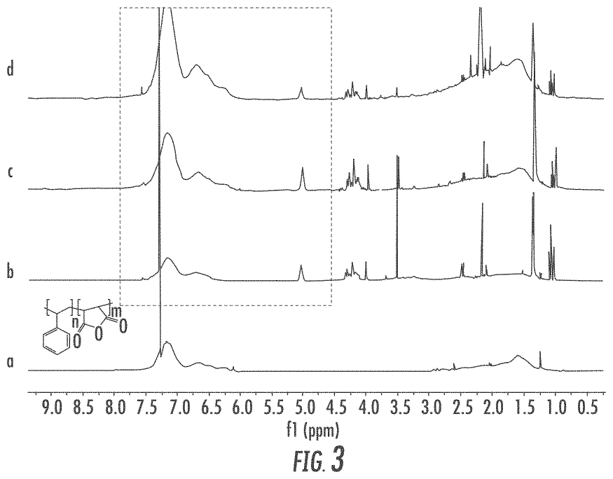

SMA is known to improve the properties of epoxy resin formulations, including raising the T_{g} and lowering the dielectric constant (U.S. Pat. No. 6,509,414). The anhydride monomers within SMA provide sites for epoxy crosslinking. PPC has been shown to be a porogen within epoxy polymer films by decomposing during or after polymer gelation (Li, et al., “Chemically Induced Phase Separation in the Preparation of Porous Epoxy Monolith,”J. Polym. Sci. Part B Polym. Phys., 48(20):2140 (2010)). However, the immiscibility of PPC with epoxy leads to phase segregation of the PPC, resulting in large pores up to several micrometers (Id.). Here, ePPC was grafted onto SMA before crosslinking with pBPADGE. Grafting PPC onto SMA can help to mitigate phase segregation since ePPC is stabilized by covalent bonding to the SMA copolymer. The ratio of styrene to maleic anhydride in the SMA was evaluated by ¹H NMR shown in FIG. 3, spectrum a. The broad peak in the range 5.75 ppm-8 ppm represents five aromatic protons (annotated as o in the chemical formula of SMA) on styrene. The broad peak in the range 0.75 ppm-3 ppm represents the remainder of the SMA protons, including three protons on a single styrene molecule (annotated as p, q, r in the chemical formula of SMA) and two protons on a single maleic anhydride molecule (annotated as s and tin the chemical formula of SMA). The ratio between the two peaks was determined to be 10:7 based on ¹H NMR spectrum. Assuming there are x moles of styrene and y moles of maleic anhydride in 1 mole of SMA, the ratio of the two peaks can be represented by 5x/(3x+2y). Since 5x/(3x+2y) is equal to 10/7, the ratio between x and y, i.e., the ratio between styrene and maleic anhydride, was determined to be 4:1.

FIG. 3, spectra b through d show the ¹H NMR for the final product of SMAg-PPCx with loadings of 10 wt %, 20 wt % and 30 wt % ePPC. The styrene to ePPC ratio before the reaction was determined by calculating number of moles of styrene and ePPC that were added into the reaction flask. The ratio between styrene and ePPC after the reaction was determined by ¹H NMR using the ratio between styrene aromatic peak o at 5.75 ppm-8 ppm and ePPC peak a at 4.92 ppm-5.02 ppm. Each styrene contains 5 aromatic protons, therefore number of moles of styrene can be calculated by dividing its integral by 5. Similarly, ePPC peak at 4.92 ppm-5.02 ppm represents 19 repeat units for the ePPC backbone. Thus, the number of moles of ePPC can be determined by dividing its integral by 19. Similar ratios of styrene to ePPC was obtained for each of the three grafting reactions. This shows that most of the ePPC added was grafted onto the SMA.

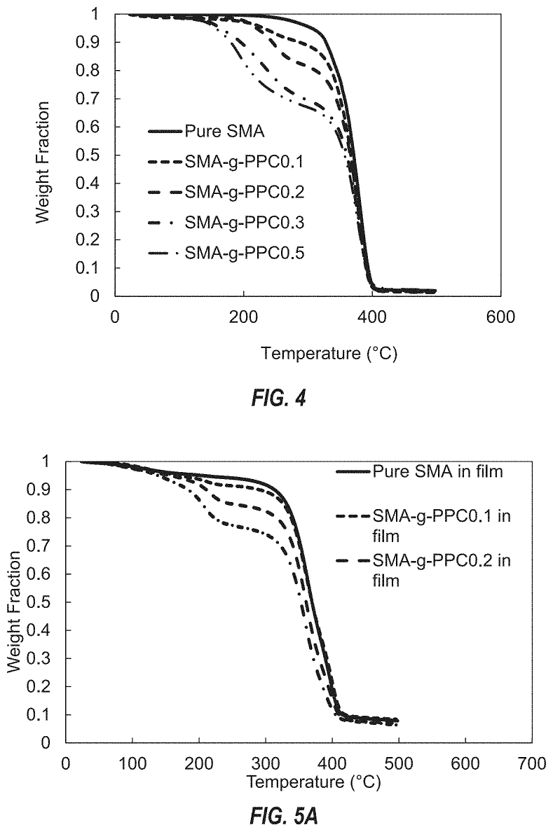

FIG. 4 shows the TGA result for the decomposition of SMAg-PPCx products. For SMA-g-PPC0.1, SMA-g-PPC0.2 and SMA-g-PPC0.3, 10%, 20% and 30% weight loss was observed between 150° C. and 300° C., while pure SMA showed no weight loss in that temperature range. The ePPC decomposition started at a lower temperature than before it was grafted onto SMA due to the addition of the amine catalyst that catalyzed the decomposition reaction. The ePPC also decomposed at a much slower rate due to the protection of the bulky end group that restrict end-unzipping. For SMA-g-PPC0.5, only 32% weight loss was observed between 150° C. and 300° C. This shows that only 64 wt % of ePPC added to the SMA for reaction resulted in SMA-g-PPC0.5 formation. The result suggests that a maximum loading of about 32 wt % PPC can be grafted onto SMA with 4:1 styrene maleic anhydride copolymer. This limitation to further grafting ePPC onto other vacant anhydride sites on SMA may be due to the steric hindrance of the grafted ePPC on the SMA.

Film Properties and Characterization:

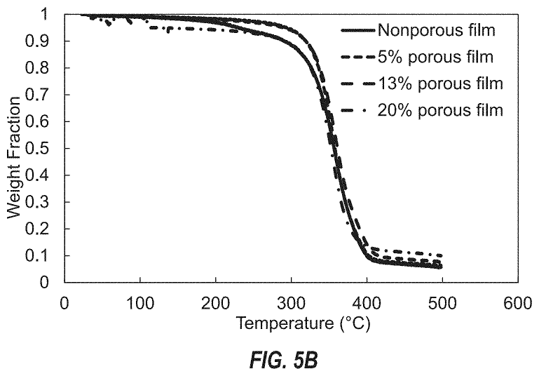

Curing of the epoxy resin film is desirable before ePPC decomposition to ensure the formation of closed pores. Thus, confirmation of crosslinking before decomposition is important. Park et al. demonstrated the cure behavior of an epoxy-anhydride-imidazole system, where a tertiary amine could initiate the crosslinking between epoxy and anhydride molecules at 75° C. for 18 hours. Crosslinking was confirmed by observing the increasing of T_{g} due to the addition of anhydride molecules in the resin formulation. For the first stage, the film was each cured at 75° C. for 18 hours to ensure that crosslinking occurred. FIG. 5A shows the TGA for the film after the first stage curing. About 5 wt % residual solvent evaporated before the decomposition of ePPC. For SMAg-PPC0.1, SMA-g-PPC0.2 and SMA-g-PPC0.3 crosslinked films, 5%, 13% and 20% weight loss was observed between 150° C. and 300° C. The pure SMA showed no weight loss in the same temperature range. This shows that ePPC decomposition did indeed occur. These films were subsequently brought to 180° C. for 6 hr and finally to 220° C. to complete the ePPC decomposition. FIG. 5B shows the TGA spectrum for the film after the decomposition of ePPC. No weight loss occurred until 320° C., suggesting that all the ePPC were removed after the 220° C. step. The density of different starting materials was similar: pBPADGE 1.17 g/cm³, SMA 1.08 g/cm³, and PPC 1.2 g/cm³.

Thus, the mass fraction of ePPC could be used to estimate the pore volume fraction inside the film, assuming the components did not change density when mixed. This results in pore volumes of 5%, 13% and 20% pore volume in the films SMA-g-PPC0.1, SMA-g-PPC0.2 and SMA-g-PPC0.3, respectively.

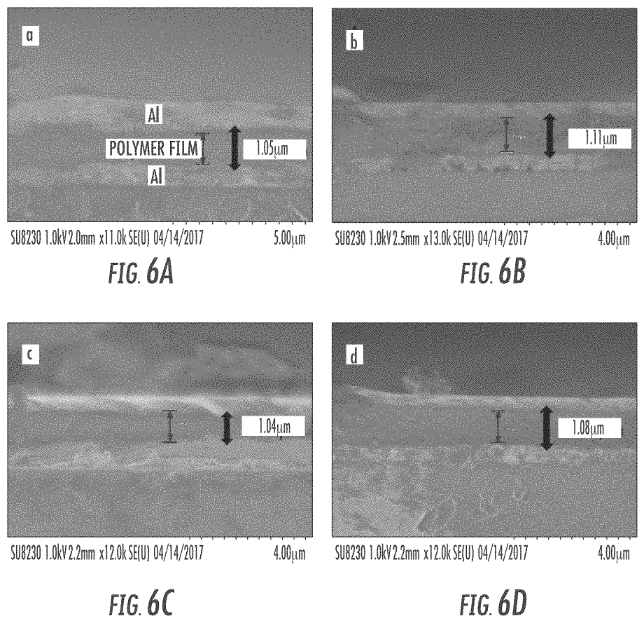

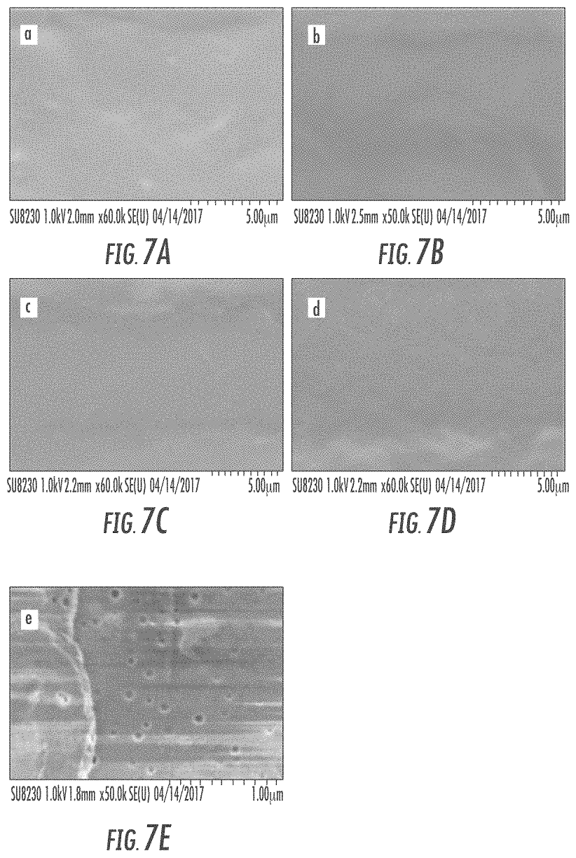

Cross-sectional SEM images of the polymer films spin-coated on aluminum coated silicon wafers are shown in FIGS. 6A-6D. Spin speed of 1500 rpm/s resulted in similar thickness of 1.05 μm, 1.11 μm, 1.04 μm, and 1.08 μm, for films with 0%, 5%, 13%, and 20% volume fraction ePPC. FIGS. 7A-7E are high magnification images to examine if the pores are large enough to be observed. FIG. 7A shows the cross section of a nonporous film where no pores were observed. FIGS. 7B and 7C show the 5% and 13% porous epoxy films where there were also no pores observed. However, in FIG. 7E, where the 10 wt % ePPC was directly mixed with SMA and pBPADGE without grafting the ePPC onto SMA before curing, large pores up to 90 nm are observed. This shows that the pores inside FIGS. 7B and 7C are small enough that using SEM to observe the pore size is difficult. FIG. 7D shows the 20% porous epoxy film where some small pores are observed.

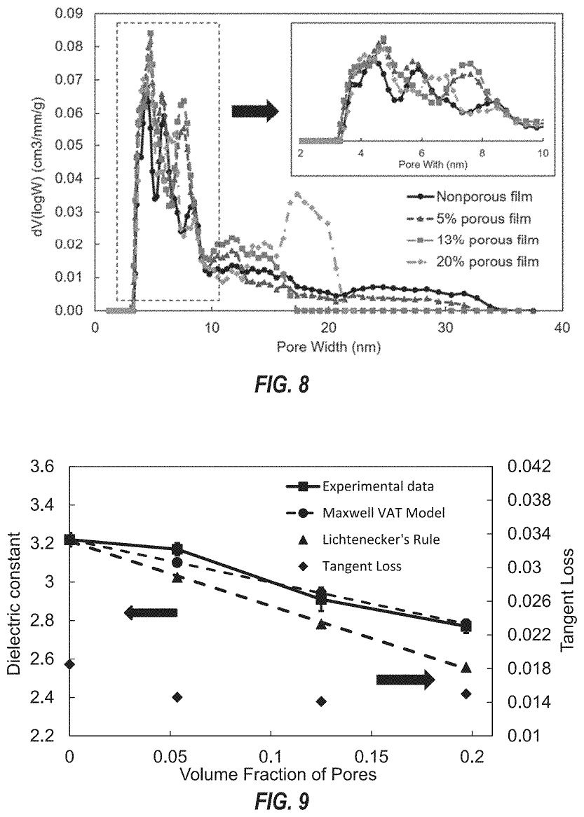

Nitrogen absorption measurements were performed to further investigate the pore size in the films. FIG. 8 shows the nitrogen absorption result for films with 0%, 5%, 13% and 20% pore volume. Free volume in the range of 3 to 5 nm was observed within all the epoxy films, including the non-porous film. This is likely due to the free volume within the crosslinked polymer chains. Pores in the range of 6 to 8 nm were found in the films with 5%, 13% and 20% porogen. The molecular size of the 2000 g/mol porogen is about 3 nm3, which is in the range of the pores found within the epoxy matrix. For the 20% porous epoxy film, larger pores between 15 to 20 nm were observed. This pore size distribution from the nitrogen absorption experiment agrees with the SEM image, where larger pores could only be observed for 20% porous epoxy film by SEM. This increase in pore size for the 20% porous epoxy film may be caused by the reaction of ePPC with other ePPC sites during the curing stage, leading to the increase of pore size upon decomposition. The densely grafted SMA-g-PPC_{0.3} has ePPC chains that are more likely to interact with each other, thus leading to an increase in the pore size.

To examine the effect of the pore volume fraction on the dielectric constant, capacitance values for different capacitor structures were measured. FIG. 9 shows the dielectric constant and loss of the formulations with the error bars set a one standard deviation. At least five capacitors were measured for each data point. For the nonporous epoxy film, the dielectric constant was 3.22 and the tangent loss was 0.0185.5% porosity into the film lowered the dielectric constant to 3.17 and the loss tangent dropped to 0.0146. Increasing the porosity to 13% lead to a film with 2.91 dielectric constant and 0.0141 loss tangent. The loss tangent may not be dropping as rapidly as the dielectric constant because of water or hydroxyl coverage of the pore walls. When the porosity was increased to 20%, dielectric constant dropped to 2.77, however the loss tangent remained about the same at 0.0150.

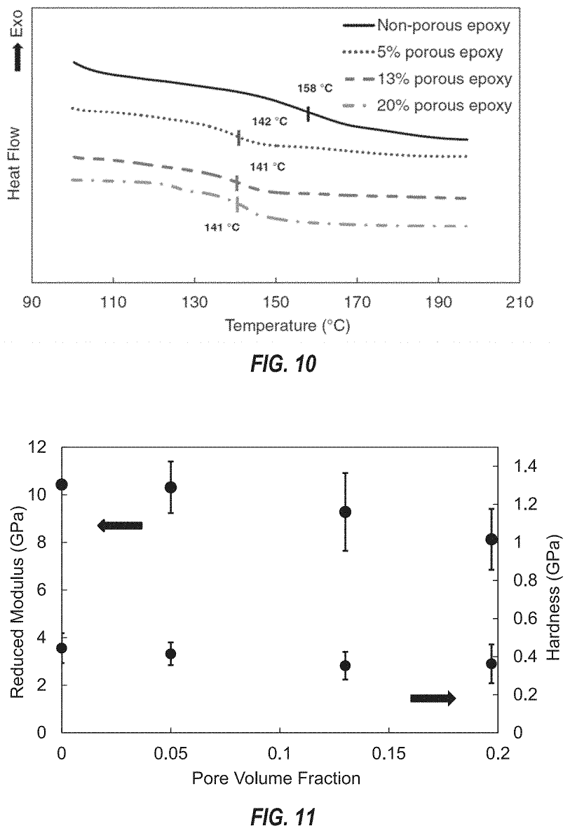

T_{g} of the crosslinked films was studied using DSC. FIG. 10 shows the DSC curve for samples containing 0%, 5%, 13% and 20% porosity. All the films have a T_{g} between 140° C. and 160° C. The non-porous epoxy/SMA crosslinked film had a T_{g} of 157° C. The T_{g} of porous films was somewhat lower at 142° C. due to the decrease of crosslink density after the decomposition of the ePPC leaving free volume for polymer chain to move in a less hindered environment.

Mechanical properties of the crosslinked films, including reduced modulus and hardness, were studied using nanoindentation, FIG. 11. For the nonporous epoxy film, the reduced modulus based was 10.4 GPa. The reduced modulus dropped slightly to 10.3 GPa for film with 5% porosity. The reduced modulus was 8.13 GPa for film with 20% porosity. The reduction in reduced modulus with increase in porosity of the epoxy film is caused by the decrease in crosslink density of the film. The decrease in crosslink density happens due to the decomposition ePPC, which was previously crosslinked to the SMA and pBPADGE. This may be corrected by changing the styrene to maleic anhydride ratio. The hardness of the film also decreased from 0.44 for nonporous epoxy film to 0.36 for the 20% porous epoxy film, due to the decrease in crosslink density caused by the increasing pore volume.

In this example was described the synthesis of SMA-grafted PPC copolymer, and used this grafting copolymer for preparation of nanoporous epoxy films. Nanoporous thin films were obtained by thermal decomposition of a PPC porogen crosslinked to the pBPADGE/SMA system. The chemical crosslinking of PPC with SMA prevented the aggregation of PPC molecules and restricted the formation of large pores inside the epoxy film. Pore size lower than 10 nm was observed inside the epoxy film with the PPC-grafted formulation. The electrical and mechanical properties of the film based on different percent pore volume was studied. The dielectric constant of the epoxy film was lowered with increasing the pore volume without significantly sacrificing the mechanical properties of the films. A new functionalized porogen materials was demonstrated in this example that could be incorporated into the epoxy film without degrading the mechanical and electrical properties of the film. The ease of processing of this low dielectric constant epoxy film makes it potentially useful for electronic applications involving advanced devices.

### Example 2: Porous Epoxy Film for Low Dielectric Constant Chip Substrates and Boards by Direct Mixing of Porogen Materials with Epoxy Resin

Lowering the dielectric constant of interconnect, substrates and boards for electronic devices is needed to achieve faster switching speed and smaller electronic device packages. A feasible way to reduce the dielectric constant of existing material is by introducing porosity within the dielectric film. The density and pore size play an important role in determining the mechanical property and electrical property of the film. An increase in the pore fraction leads to lower dielectric constant. However, higher pore fraction can deteriorate the mechanical properties. Therefore, it is important to achieve a balance between dielectric constant and mechanical properties. In this study, a low molecular weight sacrificial polymer poly(propylene carbonate) was functionalized with epoxide groups to increase its miscibility in an FR4 epoxy resin formulation by cross-linking it with the epoxy matrix. During or after curing, the epoxy resin can be heated to a temperature to generate the porous structure by evolution of the sacrificial polymer products. The mechanical and dielectric properties were measured to show the feasibility of using this modified sacrificial polymer in existing FR4 epoxy formulations to achieve lower dielectric constant interconnect.

The electronic industry is shrinking the component size and achieving faster switching speeds. With the miniaturization of components size, propagation delay, crosstalk noise and power dissipation become more predominant due to the increase in capacitance of the interconnect. Reduction in interconnect capacitance is necessary for several reasons. Since the propagation velocity, v, is inversely proportional to square root of capacitance, C, reduction in capacitance helps with the high-speed performance of a system. Moreover, v is inversely proportional to square root of inductance, L. Thus, reduction in capacitance of interconnects could help to increase the density of packaging, reduce the size, and increase the system speed. Since the capacitance is linearly proportional to dielectric constant, which depends on the polarizability of the atoms in an electric field. Atoms bonded with low polarizability bonds typically have a lower dielectric constant.

Printed circuit board (PCB) acts as both mechanical support and interconnects for electronic components. Therefore it is important to keep the dielectric constant of PCB as low as possible while keeping the mechanical property similar. PCB backbone matrix composes of epoxy resin. Epoxy resin has dielectric constant between 3.8 and 4.4. While there are other low dielectric constant polymer such as polytetrafluoroethylene, epoxy resin has advantage over other lower dielectric constant polymers for its adhesive property, strong mechanical property and low water uptake. Therefore it is the most commonly used matrix in the PCB industry. Different methods can be used to lower the dielectric constant of epoxy films. Due to the low polarizability of C-F bond, fluorination of the epoxy resin has been used to achieve lower dielectric constant. However fluorination is relatively dangerous to pursue and hard to process, making it less favorable for large scale industrial application. An alternative way to reduce the dielectric constant of epoxy resin is to introduce porous region into the epoxy matrix due to the dielectric constant of unity for air. While many methods have been applied to achieve porous epoxy, the pore sizes are too large that have limited its application in PCB interconnects. In this examples, a small sacrificial polymer molecule as a porogen material was used to create porosity for epoxy resin.

There are two possible ways of applying the epoxy into the PCB using the epoxy formulation with the porogen. The first method is using a traditional copper clad laminate (CCL) by directly applying epoxy-porogen formulation as the B-staged dielectric, followed by lamination of copper foil on the top at elevated temperature. In this process, a porous B-stage material needs to be formed before copper is clad on the top. The second method is using resin coated copper (RCC) to apply epoxy as the C-stage dielectric, as used in high density interconnect (HDI) build-up on boards. In this case, a C-staged dielectric is first formed on the copper foil to create a thin layer of epoxy. This is followed by a B-stage formulation which allows flow of the dielectric during lamination. For the CCL structure, epoxy is directly used as the dielectric. For RCC material, epoxy is C-staged between the B-stage epoxy resin and copper foil as both a dielectric layer and an adhesive layer. Both structures can provide lower dielectric constant between copper foil and other electronic components.

Epoxy Resins: Epoxy resin is an epoxide form of bisphenol A. It could be a either a Single Unit or Multiple Repeat Units of Bisphenol a Diglycidyl Ether.

Brominated form of epoxy resin is usually used as matrix for printed wiring board to improve the flame retardant property of the epoxy resin. In this example, two commercial epoxy resin were used, EPON 523 and EPON 1134. Structures are shown in Scheme 2.

Styrene Maleic Anhydride:

Styrene Maleic Anhydride, SMA, is a copolymer of styrene and maleic anhydride. It is a common crosslinker used for fabrication of epoxy based printed wiring board. Maleic anhydride units react with epoxide group using an amine based catalyst, typically imidazole, under elevated temperature. The advantage of SMA includes high thermal stability, high mechanical support, low polarizability, low water uptake content, and longer shelf life when mixed with epoxy resin. In this example, SMA4000 with 4:1 ratio of styrene to maleic anhydride was investigated. The structure of SMA is shown in Scheme 2.

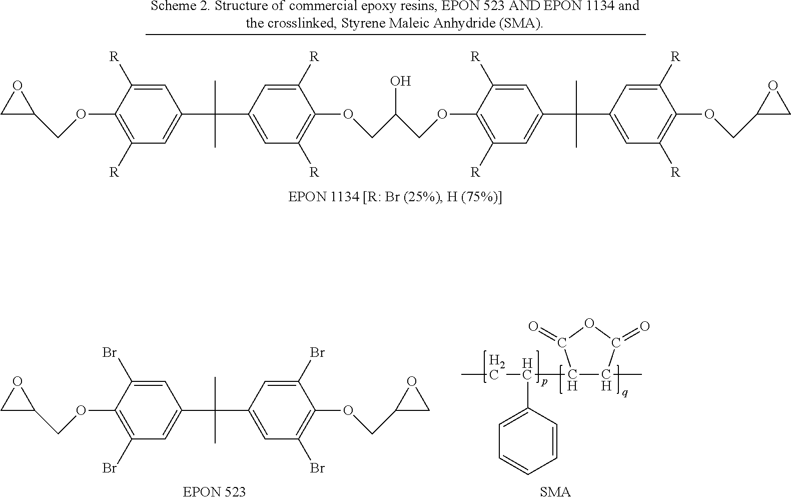

Sacrificial Polymers:

There are different types of sacrificial polymers that could be used for pore generation of a polymer film, including poly(aldehyde), poly(caprolactone), poly(norbonene), polylactide, polyacrylic etc. However those polymers may have high non-volatile residual content after decomposition or have higher decomposition temperature that goes beyond the degredation temperature of epoxy resin. Polypropylene carbonate, PPC, is used in this example as a sacrificial polymers to create void volume in the films. It is synthesized by the copolymerization of propylene oxide and carbon dioxide using organometallic catalyst, typically zinc glutarate. More recently, low molecular PPC, e.g. 1 kDa, 2 kDa, were synthesized. PPC is biodegradable and biocompatible. It has low glass transition temperature, varying from 10° C. to 45° C. depending on the molecular weight. It has advantage over other sacrificial polymers for its relatively low decomposition temperature and low residual leftover after decomposition. The decomposition mechanism could be either chain end unzipping, which normally takes place at around 180° C., or chain scission, which normally takes place at higher temperature, 200° C. Chain end unzipping mechanism generates propylene carbonate, while chain scission mechanism generated carbon dioxide and acetone. End capping of PPC has been used to stabilize the PPC at higher temperature for wider processing window. Owing to the hydroxyl functionality at its chain ends, PPC can be easily functionalized using S_{N}2 nucleophilic substitution to create functionalized end group. This reaction can take place at room temperature due to its exothermic nature. End capping PPC suppressed the generation of less volatile propylene carbonate caused by chain end unzipping and promote the random chain scission mechanism to create more volatile chemicals. The decomposition temperature of PPC fit well with epoxy resin. The decomposition temperature is high enough for epoxy to crosslink, while it is also low enough that PPC can be removed before phase change and degradation of epoxy resin matrix occur.

Accelerator:

Commercially available imidazole catalyst, 2-ethyl-4-methylimidazole (2E4MI) was used as the accelerator for the crosslinking. Nitrogen atom on imidazole molecule acts as the base that can deprotonate the α-hydrogen on anhydride ring, leading to the accelerated ring-opening process at elevated temperature. Adding too much imidazole can cause the undesired dielectric loss increase due to the polarity of N-H bond. In this case, 0.48 wt % of 2E4MI with respect to the solid content in each vial was added according to a commercial fabrication process.

Chemical Functionalization of PPC:

Neat PPC has the tendency to aggregate with itself while mixing with epoxy resin. Pore size up to 10 microns were observed previously by mixing 100 kDa PPC with epoxy resin. Large pore size affects significantly on the mechanical strength of epoxy resin. To avoid aggregation of pores as much as possible, two approaches were used in this study. First, lower molecular weight PPC, 2 kDa, was used as the sacrificial materials. Second, end groups of PPC were functionalized to epoxide group to allow better miscibility with epoxy resin.

Traditional epoxidation of bisphenol A was done using sodium hydroxide as the catalyst and epichlorohydrin as the end cap reagent to achieve epoxide functionalization. However, owing to the poor stability of PPC to strong base, and creation of alkoxide intermediate anion, PPC easily degrades into propylene carbonate (side product for unzipping degradation) at room temperature. The intermediate alkoxide anion is generated due to the ring-opening reaction of epichlorohydrin. Therefore an alternative functionalization method was established. A two-step functionalization was done to achieve the epoxide functionalized PPC as shown in Scheme 1 above. The first step involves adding allyl groups on ends of PPC. This is followed by using a strong oxidation reagent, meta-chloroperbenzoic acid, to oxidize the double bond using Prilezhaev reaction and form epoxide groups. Both steps were carried out at room temperature to avoid the depolymerization of PPC. Successful >99.9% conversion of hydroxyl end group to epoxide end group for 2 kDa PPC as well, with the end group to repeat unit ratio of 1:10 (peak b at 2.8 ppm to peak a at 5 ppm) was obtained. The epoxide PPC also has a decomposition temperature that falls within the processing window of epoxy resin, as shown in FIG. 12. The clear stabilization of epoxide end group is demonstrated by the thermogravimetric analysis (TGA), where the decomposition temperature was elevated by 20° C. to 200° C. This indicates that the main decomposition mechanism of epoxide PPC will be through the random chain scission. This is favorable for the process as chain scission mechanism will generate more volatile chemicals.

Formulation and Curing Process:

The epoxide PPC was mixed with the epoxy resin and SMA with different weight ratio. Equivalent ratio of anhydride to epoxide group was controlled for all formulations in order to achieve a complete crosslinked network for optimal mechanical properties.

Mixing was done in three steps. Different weight percent of epoxide PPC was pre-dissolved using MEK in different vials, while the respective epoxy resin and SMA were pre-dissolved in separate vials. In this case, weight percentage of PPC with respect to total solid content can be used to estimate the final porosity of the film due to similar density of polymer contents. Sonication was done to ensure complete mixing of each vial. The dissolved epoxide PPC were poured into the respective epoxy resin and SMA vials and sonicated again to ensure the homogeneous mixing. Catalyst 2E4MI was lastly added into each vial and sonicated again to ensure the complete dissolution.

Prepared formulations were then spin-coated onto either silicon wafer or aluminum coated wafer with varied thickness for further characterization purpose. Films prepared by spin-coating were then cured in a tube furnace by following the procedures below:

1. Ramp 1° C./min to 35° C., and isothermal for 1 hr.

2. Ramp 0.5° C./min to 150° C., and isothermal for 3 hr.

3. Ramp 1° C./min to 180° C., and isothermal for 6 hr.

4. Ramp 0.6° C./min to 230° C., and isothermal for 1 hr.

Step 1 is used as a soft bake stage to remove most of the solvent. Step 2 is used for crosslinking the epoxide group with SMA at a slow ramp rate. Step 3 is designed to completely cure epoxy resin and to start decomposition of PPC. Step 4 aims to completely decompose epoxide PPC and remove any residuals inside the porous region.

The finished samples were further immersed in hexamethyldisilazane (HMDS) vapor to hydrophobically treat the exposed hydrophilic group. Silane head group typically has low polarizability, which can help with mitigating dielectric loss of the porous epoxy film. Hydrophilic group could appear inside the wall of pore due to the epoxy crosslinking and PPC decomposition. Typical hydrophilic group for this film is hydroxyl group. HMDS could diffuse into the film and pores due to its small molecule size and react with hydroxyl group. There are two steps of nucleophilic substitution for each HMDS molecule with hydroxyl group to cover the hydrophilic group exposed inside the pore. HMDS has several advantage over other silane molecules. It contains symmetric silane group that can react with two hydroxyl group, and it generate volatile NH₃ gas that can leave the film without traces behind.

Characterization of Electrical, Optical and Mechanical Properties

Ellipsometry

A common way to indirectly determine the appearance of pores inside the film is to use ellipsometer to measure the refractive index. Due to the transparency of the epoxy film, a Cauchy equation model could be used to fit in the experimental data. With the increase of the porosity, the refractive index should decrease. FIG. 13 shows the refractive index for various films with different porosity. It is obvious that with the increase of the porosity, the refractive decreases.

Scanning Electron Microscope

To further investigate the details of the pore, scanning electron microscope was used. The cross sectional area of films were investigated. Assuming the spherical shape of a single molecule, the theoretical radius of a molecule could be estimated by using equation

$$r = {( \frac{3 {M}_{n}}{4 π {N}_{A} ρ} )}^{1 / 3}$$

Mₙ is the number average molecular weight of the polymer, NA is the Avogadro's number, p is the density of the polymer. For epoxide PPC, ρ=1.3 g/cm3. Based on this equation, theoretical pore size for 2 kDa and 1 kDa epoxide PPC is 0.85 nm and 0.43 nm respectively. SEM image shows the pore size of a 20 wt % and 30 wt % 2 kDa PPC loaded film. Average pore size of 30 nm was obtained for 20% porous film as shown in FIG. 14 (top), while average pore size over 100 nm was obtained for 30% porous film in FIG. 14 (bottom). Some aggregation of epoxide PPC happens due to reactivity of the epoxide PPC to itself and to epoxy resin. This aggregation increases when the epoxide PPC content is high.

Nanoindentation

The biggest impact of pore size for a film is on the mechanical property. Therefore to verify how different loadings of epoxide PPC affect the mechanical strength of the film, nanoindentation was used to characterize the mechanical property, including reduced modulus and hardness of the film. Reduced modulus can be calculated using equation below:

$${E}_{r} = \frac{1}{β} \frac{\sqrt{π}}{2} \frac{S}{\sqrt{{A}_{p} ( {h}_{c} )}}$$

β is a geometric constant, S is the stiffness of the material, Aₚ is the projected area of the indentation at different contact depth h_{c}. The reduced modulus is basically the modulus of a material at its z-direction. Reduced modulus can be converted to more commonly used Young modulus using equation below:

$$\frac{1}{{E}_{r}} = \frac{1 - {v}_{i}^{2}}{{E}_{i}} + \frac{1 - {v}_{s}^{2}}{{E}_{s}}$$

Vᵢ is the poisson ratio of the indenter, which in this case is diamond tip and its poisson ratio is 0.07. Vs is the poisson ratio of the testing material, which for epoxy resin is around 0.3.

For accurate measurement of nanoindentation, indent depth need to be controlled less than 10% thickness of the sample in order to avoid the substrate effect. FIG. 15 shows the reduced modulus and hardness of the film made using 2 kDa epoxide PPC with SMA4000. For films made out of SMA4000, it is obvious that with porosity up to 25%, both hardness and reduced modulus were not significantly affected, around 4 GPa for reduced modulus and 0.2 GPa for hardness. The converted young modulus is around 8 GPa, which lies in the range of a fully cured epoxy resin. When porosity increases to 30%, a significant decrease in the reduced modulus to around 2.2 GPa occurs. This mechanical strength agrees with the SEM image, where large pore size show up when 30 wt % epoxide PPC was added to create 30% porosity. A conclusion can be drawn that loadings up to 25% porous area can be achieved between SMA4000 and 2 kDa epoxide PPC to still maintain small enough pore size that won't significantly affect the mechanical properties.

Dielectric Measurements

Epoxy films were sandwiched between two layers of aluminum to create a capacitor structure to measure dielectric properties. Bottom aluminum layer was evaporated onto silicon wafer, while top aluminum metal was deposited using shadow mask with designated surface area. Dielectric properties were measured using an LCR meter, with frequency set to maximum of the tool at 200 kHz and voltage also at maximum at 1.275 V. Theoretically, dielectric constant and dielectric loss drops with the increase of the frequency due to the reduction in resonant frequency of small molecules that might be left over inside the film after curing. FIG. 16 shows the dielectric constant of the film at porosity of 0%, 11.3%, and 22.3%. The original epoxy resin used has dielectric constant at 3.865. With the addition of 22.3% pore volume inside the film, the dielectric constant drops to 2.864. However, the dielectric loss slightly goes up from 0.009 to 0.012. This results from the decomposition of more epoxide PPC that leaves more hydrophilic group inside the pore. HMDS treated samples show a decrease in dielectric loss as expected in FIG. 16. Dielectric loss of nonporous epoxy film is similar before and after HMDS treatment because of its nonporous nature. Film with porosity of 22.3% achieve dielectric loss as low as 0.0052. The confirmation of hydrophobic treatment of HMDS is confirmed based on the decreasing in dielectric loss of porous films.

Demonstrated in this example is a formulation of porous epoxy resin using an epoxide modified low molecular weight PPC as porogen materials. A reduction of dielectric constant can be achieved with suitable amount of loadings of epoxide PPC. Dielectric constant as low as 2.86 has been achieved for a commercial epoxy resin without sacrificing the mechanical property while keeping dielectric loss as low as 0.0052 after hydrophobic treatment.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A composition comprising a copolymer derived from:
a) an epoxy resin;
b) an epoxy-functionalized sacrificial polymer; and
c) optionally a crosslinker.

2. A composition comprising a copolymer derived from:
a) an epoxy resin;
b) a polycarbonate sacrificial polymer; and
c) optionally a crosslinker.

3. The composition of claim 1, wherein the sacrificial polymer is derived from a polycarbonate, a polyaldehyde, a polysulfone, a polynobornene, a polycarbamate, or a combination thereof.

4. The composition of claim 1, wherein the sacrificial polymer is a polycarbonate comprising repeating units represented by the general formula of: 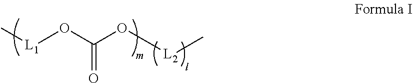
wherein L₁ and L₂ independently represent substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-aryl, or substituted or unsubstituted C₆ to C₂₀-heteroaryl; and
m is an integer from 1 to 10,000; and
l is an integer from 0 to 10,000.

5. (canceled)

6. (canceled)

7. The composition of claim 1, wherein the sacrificial polymer has a molecular weight of from 1,000 Da to 10,000 Da.

8. (canceled)

9. The composition of claim 1, wherein the sacrificial polymer is present in an amount of from 5% to 35%, based on the total weight of the polymers in the composition.

10. (canceled)

11. The composition of claim 1, wherein the optional crosslinker is present and comprises an amine, mercaptan, or an anhydride functional group.

12. (canceled)

13. (canceled)

14. The composition of claim 1, wherein the epoxy resin comprises repeating units represented by the general formula of: 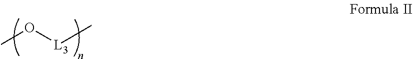
wherein L₃ is selected from substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-aryl, or substituted or unsubstituted C₆ to C₂₀-heteroaryl; and
n is an integer from 1 to 10,000.

15. (canceled)

16. (canceled)

17. The composition of claim 1, wherein the copolymer comprises repeating unit as shown in Formula III: 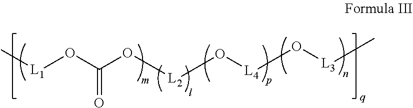
wherein Li, L₂, and L₃ independently represent substituted or unsubstituted linear and branched C₁ to C₂₀-alkyl, substituted or unsubstituted linear and branched C₂ to C₂₀-alkenyl, substituted or unsubstituted linear and branched C₂ to C₂₀-alkynyl, substituted or unsubstituted C₆ to C₂₀-cycloalkyl, substituted or unsubstituted C₆ to C₂₀-aryl, or substituted or unsubstituted C₆ to C₂₀-heteroaryl;
L₄ represents a crosslinker;
l is an integer from 0 to 100,000;
m is an integer from 1 to 100,000;
n is an integer from 1 to 100,000;
p is an integer from 0 to 100,000; and
q is an integer from 1 to 100,000.

18. A method of preparing a copolymer according to claim 1 comprising:
(i) blending an expoxidized sacrificial polymer with an epoxy resin, optionally a crosslinker, and a solvent to form a solution; and
(ii) curing the solution comprising the expoxidized sacrificial polymer, the epoxy resin, and the optional crosslinker to form the copolymer.

19. A method of preparing a copolymer comprising:
(i) epoxidizing a sacrificial polymer to form an epoxidized sacrificial polymer;
(ii) optionally grafting the epoxidized sacrificial polymer onto a crosslinker to form a grafted epoxidized sacrificial polymer;
(iii) blending the epoxidized sacrificial polymer or grafted epoxidized sacrificial polymer with an epoxy resin and a solvent to form a solution; and
(iv) curing the solution comprising the epoxidized sacrificial polymer or grafted epoxidized sacrificial polymer and the epoxy resin to form a copolymer.

20. The method of claim 19, wherein epoxidizing the sacrificial polymer comprises:
reacting the sacrificial polymer with an epoxide precursor to form a capped sacrificial polymer; and
oxidizing the epoxide precursor in the capped sacrificial polymer to form the epoxidized sacrificial polymer.

21. (canceled)

22. (canceled)

23. (canceled)

24. The method of claim 19, wherein epoxidizing the sacrificial polymer comprises:
reacting the sacrificial polymer with an epihalohydrin such as epichlorohydrin, epifluorohydrin, or epibromohydrin in the presence of a base.

25. (canceled)

26. (canceled)

27. (canceled)

28. (canceled)

29. (canceled)

30. (canceled)

31. (canceled)

32. The method of claim 18, wherein the optional crosslinker is present and the weight ratio of the sacrificial polymer to crosslinker is from 1:1 to 1:10.

33. (canceled)

34. A porous film derived from a composition according to claim 2, wherein a majority of the sacrificial polymer in the composition has been degraded to form pores in the porous film.

35. (canceled)

36. (canceled)

37. (canceled)

38. The porous film of claim 34, wherein from 5% to 40% of the pores have a closed cell structure.

39. The porous film of claim 34, wherein the pores have an average pore size of less than 500 nm.

40. The porous film of claim 34, wherein the film has a pore volume of from 5% to 40%, based on the volume of the film.

41. A method of forming a porous film comprising:
(i) depositing a layer comprising an epoxy resin, an epoxy-functionalized sacrificial polymer, and optionally a crosslinker on a substrate;
(ii) curing the epoxy resin, the epoxidized sacrificial polymer, and the optional crosslinker to form a copolymer;
(iii) causing a majority of the sacrificial polymer present in the copolymer to decompose into one or more gaseous decomposition products; and
(iv) removing the one or more gaseous decomposition products by passage through a solid portion of the film.

42. (canceled)

43. (canceled)

44. (canceled)

45. (canceled)

46. (canceled)

47. (canceled)

48. (canceled)

49. (canceled)

50. (canceled)

51. The porous film of claim 34, wherein the porous film exhibits a dielectric constant of less than 3.5.
